(19) United States
(12) Patent Application Publication
(10) Pub. No.: US 2010/0296395 A1
(43) Pub. Date: Nov. 25, 2010

(54) PACKET TRANSMISSION SYSTEM, PACKET TRANSMISSION APPARATUS, AND PACKET TRANSMISSION METHOD

(75) Inventors: Isamu Fukuda, Kawasaki (JP); Katsuhiko Negoto, Kawasaki (JP); Toshifumi Inoue, Kawasaki (JP); Kiyohisa Hoshino, Kawasaki (JP); Nobuyuki Fukuda, Kawasaki (JP); Yoshiaki Fukunaga, Kawasaki (JP); Satoru Hirasawa, Kawasaki (JP); Kenji Fukuda, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/783,724

(22) Filed: May 20, 2010

(30) Foreign Application Priority Data
May 22, 2009 (JP) 2009-124731

(51) Int. Cl. H04L 12/26

(52) U.S. Cl. 370/230

(57) ABSTRACT

A first apparatus includes a sending unit which attaches a sequence number which is numbered for each priority of QoS set in a first packet, the sequence number is numbered for each priority of QoS set in the first packet, and sends the first packet with the sequence number. A second apparatus includes a storage unit which stores, for each priority, a history of sequence numbers attached to packets received, a determining unit which receives the first packet from the first apparatus, identifies the sequence number of the first packet, and determines whether the first packet has been previously received by comparing the identified sequence number with the history of sequence numbers according to the priority of QoS set in the first packet stored in the storage unit, and a unit which discards, when the determining unit determines the first packet has been previously received, the first packet.

### CROSS-REFERENCE TO RELATED APPLICATIONS

This application is based upon and claims the benefit of priority of the prior Japanese Patent Application No. 2009-124731, filed on May 22, 2009, the entire contents of which are incorporated herein by reference.

### FIELD

The present invention relates to a packet transmission system, packet transmission apparatus, and a packet transmission method.

### BACKGROUND

Replay attacks are one type of threat on a network. In a replay attack, a malicious third party eavesdrops to acquire authentication data being transmitted over the network. Subsequently, the malicious third party carries out a masquerade attack by transmitting the authentication data that was acquired by eavesdropping, and attempts to achieve an unauthorized login into another party's system.

Replay attack check technology using sequence numbers exists as a countermeasure against replay attacks. A replay attack check using sequence numbers will now be simply described using the example shown in FIG. 21. Herein, in the example shown in FIG. 21, a Node A and a Node C executing IPsec conduct packet communication via a Router that executes transmission control by means of QoS.

The packet-sending Node A attaches a sequence number to each packet sent to Node C. The sequence number is increased by 1 each time a packet is sent, with no relation to the packet priority. In addition, Node C stores an incoming sequence number history of sequence numbers received from Node A. When a packet is received, Node C may, for example, determine whether or not the sequence number is less than or equal to a number determined in advance from the largest sequence number received in the past. At this point, the packet acquired by the malicious third party is a packet from the past, and its sequence number is smaller than the largest sequence number. For this reason, Node C determines that the sequence number is small, and discards the packet. Herein, this predetermined number is also referred to as the replay window size.

Meanwhile, Quality of Service (QoS) is an established technology for ensuring the quality of communication on a network. An apparatus that executes transmission control by means of QoS prioritizes transmission of packets set with a relatively high priority over packets set with a relatively low priority.

In addition, the Security Architecture for the Internet Protocol (IPsec) is one example of an established network security-related technology. When sending and receiving packets with respect to apparatus executing IPsec, the packet-receiving apparatus and the packet-sending apparatus agree upon the cryptographic type and cryptographic key in advance, and then transmit packets using the agreed-upon cryptographic type and cryptographic key. Herein, the act of agreeing upon a cryptographic type and cryptographic key by apparatus executing IPsec is referred to as establishing a security association (SA).

Furthermore, the establishment of separate SAs for QoS differentiation is an established technology for checking replay attacks (RFC 4301, section 4.1, line 716). Besides the above, another technology has been established wherein, for a series of sequence numbers attached by the packet-sending apparatus, the receiving apparatus manages the series based on QoS priority.

Literature regarding technology relating to the present application includes Japanese Laid-Open Patent Publication Nos. 2005-260520 and 2005-64594.

The technology of the related art described above establishes separate SAs based on QoS priority. For this reason, the above technology involves managing agreed-upon cryptographic types and cryptographic keys for each QoS, and the quantity of data to be managed becomes very large.

Furthermore, in the technology wherein the receiving apparatus manages sequence numbers based on QoS priority, the order might be switched among packets set with the same QoS priority. In this case, the invalid discarding of packets is not prevented.

For example, the packet-sending apparatus is not limited to sending consecutive packets set with the same QoS priority, and might also attach numbers far removed from the replay window size to consecutive packets set with the same QoS priority. To give a more specific example, the sequence numbers 3 and 16 might be attached to consecutive packets set with the same QoS priority.

In this case, if the order is switched among packets set with the same QoS priority, then the packet-receiving apparatus will receive 3 after 16. As a result, in the case where the replay window size is 4, the apparatus that receives the packets will determine that 3 is smaller than the replay window size, and discard the packet attached with the sequence number 3. Invalid discarding of packets thus Occurs.

### SUMMARY

According to an aspect of the invention, a packet transmission system includes: a packet-sending apparatus; and a packet-receiving apparatus; wherein the packet-sending apparatus includes a sending unit configured to attach a sequence number which is numbered for each priority of QoS set in a first packet to be sent, the sequence number is numbered for each priority of QoS set in the first packet, and to send the first packet with the sequence number attached, the packet-receiving apparatus includes a storage unit configured to store, for each priority, a history of sequence numbers attached to packets received from the packet-sending apparatus, a determining unit configured to receive the first packet from the packet-sending apparatus, to identify the sequence number of the first packet, and to determine whether or not the first packet has been previously received by comparing the identified sequence number with the history of sequence numbers according to the priority of QoS set in the first packet stored in the storage unit, and a unit configured, when the determining unit determines the first packet has been previously received, to discard the first packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a sequence diagram for giving an overview of a packet transmission system in accordance with Embodiment 1;

FIG. 2 is a block diagram for giving an overview of a packet transmission system in accordance with Embodiment 1;

FIG. 3 is a diagram for explaining an example of a wireless network to which a packet transmission system in accordance with Embodiment 1 has been applied;

FIG. 4 is a diagram for explaining an example of information stored in a sender policy storage unit in Embodiment 1;

FIG. 5 is a diagram for explaining an example of information stored in a sender SA storage unit in Embodiment 1;

FIG. 6 is a diagram for explaining an IKE packet in Embodiment 1;

FIG. 7 is a sequence diagram for explaining the flow of an SA establishment process in a packet transmission system in Embodiment 1;

FIG. 8 is a flowchart for explaining the flow of a packet sending process conducted by a packet-sending apparatus in Embodiment 1;

FIG. 9 is a flowchart for explaining the flow of a packet receiving process conducted by a packet-receiving apparatus in Embodiment 1;

FIG. 10 is a diagram for explaining advantages obtained by a packet transmission system in Embodiment 1;

FIG. 11 is a diagram for explaining an example of information stored in a receiver SA storage unit in Embodiment 2;

FIG. 12 is a diagram for explaining an example of information stored in a receiver SA storage unit in Embodiment 2;

FIG. 13 is a flowchart for explaining the flow of a packet receiving process conducted by a packet-receiving apparatus in Embodiment 2;

FIG. 14 is a diagram for explaining an example of information stored in a receiver SA storage unit in Embodiment 3;

FIG. 15 is a diagram for explaining an example of information stored in a receiver SA storage unit in Embodiment 3;

FIG. 16 is a flowchart for explaining the flow of an SA establishment process in Embodiment 3;

FIG. 17 is a diagram for explaining a replay attack check process conducted using a Sequence Number Retention Format;

FIG. 18 is a flowchart for explaining the flow of a replay attack check process conducted using a Sequence Number Retention Format;

FIG. 19 is a flowchart for explaining the flow of a replay attack check process conducted using a Most Recent Sequence Number Format;

FIG. 20 is a diagram for explaining an example of a computer that executes a packet transmission program in accordance with Embodiment 1; and

FIG. 21 is a diagram for explaining technology of the related art.

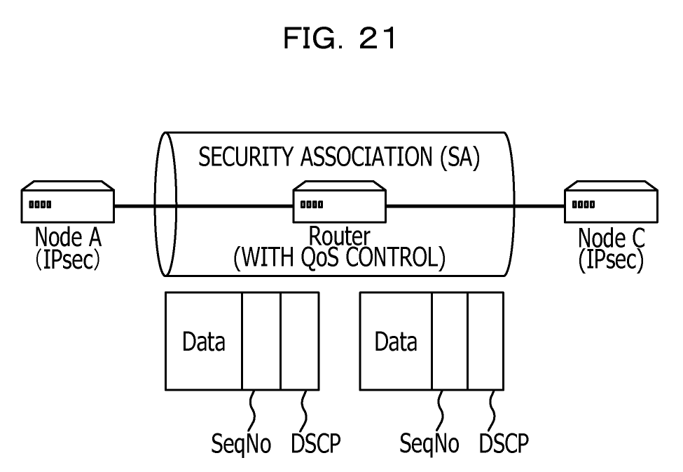

### DESCRIPTION OF THE PREFERRED EMBODIMENTS

Hereinafter, embodiments of the packet transmission system, packet transmission apparatus, and packet transmission method disclosed in the present application will be described in detail and with reference to the accompanying drawings. However, it should be appreciated that the invention is not limited to these exemplary embodiments.

### Embodiment 1

### Overview of Packet Transmission System

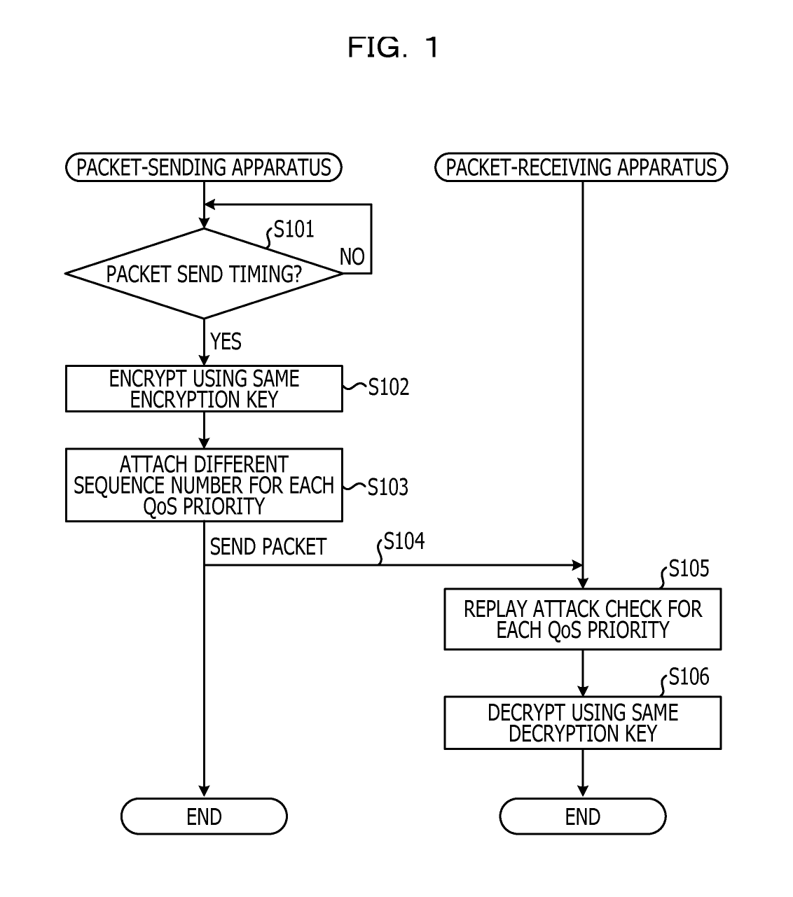

First, an overview of a packet transmission system in accordance with Embodiment 1 will be given using FIG. 1. FIG. 1 is a sequence diagram for giving an overview of a packet transmission system in accordance with Embodiment 1.

The packet transmission system in accordance with Embodiment 1 includes a packet-sending apparatus and a packet-receiving apparatus. In addition, the packet-sending apparatus and the packet-receiving apparatus establish an SA, and as described hereinafter, transmit packets in accordance with the established SA. Herein, an SA indicates an agreement made by apparatus executing IPsec.

More specifically, as illustrated in FIG. 1, when the packet-sending apparatus in Embodiment 1 reaches a packet-sending timing (step S101: Yes), the packet-sending apparatus encrypts packets set with different QoS (also referred to as speech quality) priorities using the same encryption key (step S102). For example, the packet-sending apparatus encrypts packets using the same encryption key, both when the QoS priority set in the packet is expedited forwarding (EF), and when the QoS priority is best effort (BE).

Subsequently, the packet-sending apparatus in Embodiment 1 attaches multiple series of sequence numbers to the encrypted packets, with the series differing for each QoS priority set in the packets (step S103). The packet-sending apparatus then sends the packets to the packet-receiving apparatus (step S104). Thus, for example, the packet-sending apparatus does not attach the same series of sequence numbers to packets in the transmission order regardless of whether the QoS priority is EF or BE. Instead, the packet-sending apparatus distinguishes among the QoS priorities set in the packets to be sent by attaching a different series of sequence numbers for each QoS priority.

Subsequently, upon receiving packets from the packet-sending apparatus, the packet-receiving apparatus in Embodiment 1 conducts a replay attack check for each QoS priority (step S105).

More specifically, the packet-receiving apparatus is provided with a storage unit that stores, for each priority, a history of the sequence numbers attached to packets received from the packet-sending apparatus. The packet-receiving apparatus distinguishes among the sequence numbers attached to the received packets by the sender. By cross-referencing the histories stored in the storage unit in association with the QoS priorities set in the received packets, the packet-receiving apparatus determines whether or not a received packet has already been received.

If the packet-receiving apparatus in Embodiment 1 subsequently determines that a packet has not already been received, then the packet-receiving apparatus decrypts the packet using the same decryption key as that used with respect to packets set with different QoS priorities (step S106).

In so doing, the packet-sending and packet-receiving apparatus in Embodiment 1 are able to suitably realize a replay attack check. More specifically, the number of cryptographic keys is kept to a minimum. Furthermore, since checks are conducted using different sequence numbers for each priority, it is possible to prevent the invalid discarding of packets that may occur as a result of inversions in the packet receive order due to priority differences.

[Details of Packet Transmission System]

Hereinafter, a block diagram will be first used to simply describe a configuration of the packet transmission system that was described using FIG. 1. Thereafter, the packet transmission system will be described in detail as part of an explanation of processes executed by the packet transmission system.

Also, a technique is described hereinafter as part of Embodiment 1, wherein a single SA is established with respect to different QoS priorities, and wherein a different series of sequence numbers is attached for each QoS priority set in the packets.

The technique herein described in Embodiment 1 corresponds to the “List Sequence Format”, which is one of the sequence control formats hereinafter described.

[Configuration of Packet Transmission System]

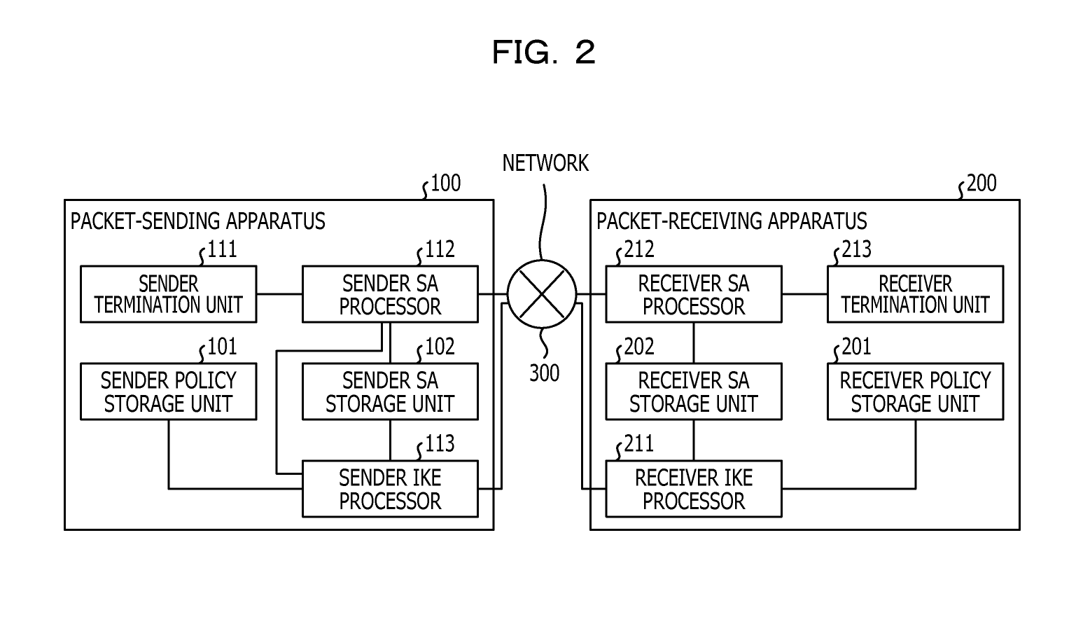

FIG. 2 will now be used to simply describe a configuration of the packet transmission system that was described using FIG. 1. FIG. 2 is a block diagram for explaining a configuration of a packet transmission system in accordance with Embodiment 1.

As shown in FIG. 2, the packet transmission system is provided with a packet-sending apparatus 100 and a packet-receiving apparatus 200, with the packet-sending apparatus 100 and the packet-receiving apparatus 200 being connected via a network 300. In addition, in the packet transmission system, the packet-sending apparatus 100 and the packet-receiving apparatus 200 send and receive packets using cryptographic technology. More specifically, the apparatuses establish an IPsec SA, and then send and receive packets in accordance with the established SA.

Furthermore, although not illustrated in FIG. 2, an apparatus that conducts transmission control by means of QoS relays the sending and receiving of packets on the network 300 between the packet-sending apparatus 100 and the packet-receiving apparatus 200.

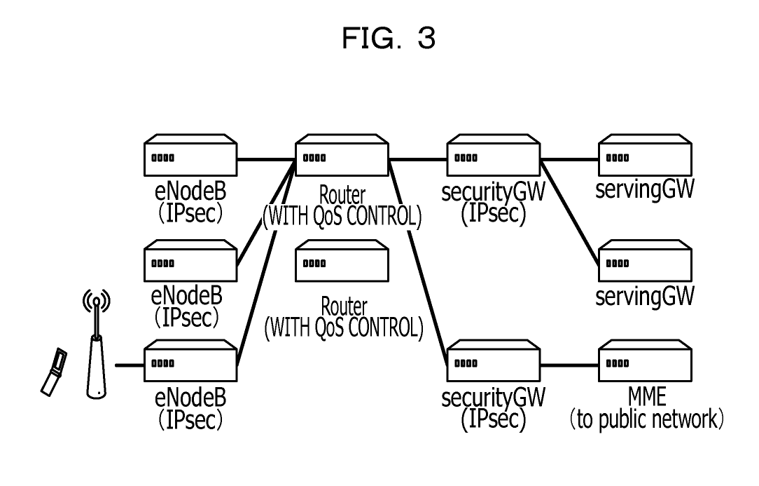

As shown by way of example in FIG. 3, the packet transmission system is adapted for a wireless network system such as Long Term Evolution (LTE). Herein, FIG. 3 is a diagram for explaining an example of a wireless network to which a packet transmission system in accordance with Embodiment 1 has been applied.

In the example shown in FIG. 3, the wireless network system is made up of wireless base stations (eNodeB), security gateways (securityGW), and serving gateways (servingGW), with an IPsec SA being applied to the data transmission among the respective apparatuses. In addition, the type of data transmitted over the wireless network system is a mixture of audio data and packet data, and transmission control by means of QoS is conducted. In the example shown in FIG. 3 herein, apparatus such as the security gateways, serving gateways, and wireless base stations correspond to packet-sending apparatus 100 and packet-receiving apparatus 200, while the Router corresponds to the apparatus present on the network 300 that conducts transmission control by means of QoS.

For the sake of convenience herein, Embodiment 1 is described using the packet-sending apparatus 100 and the packet-receiving apparatus 200. However, it should be appreciated that the present invention is not limited thereto, and that packet transmission apparatus that both send and receive packets may also be used.

[Configuration of Packet-Sending Apparatus]

Respective units provided in the packet-sending apparatus 100 will now be simply described. The packet-sending apparatus 100 is connected to the packet-receiving apparatus 200 via the network 300, and is provided with a sender policy storage unit 101, a sender SA storage unit 102, a sender termination unit 111, a sender SA processor 112, and a sender IKE processor 113.

Among the respective units provided in the packet-sending apparatus 100, the sender policy storage unit 101 and the sender SA storage unit 102 store data used for various sending processes executed by the packet-sending apparatus 100.

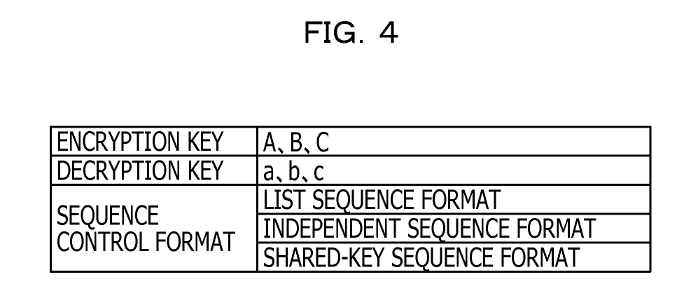

The sender policy storage unit 101 is connected to the sender IKE processor 113, and as shown in FIG. 4, stores information usable by the packet-sending apparatus 100 for SA. In the example shown in FIG. 4, encryption keys, decryption keys, and sequence control formats usable by the packet-sending apparatus 100 are stored. Herein, FIG. 4 is a diagram for explaining an example of information stored in a sender policy storage unit in Embodiment 1.

In the example shown in FIG. 4, the packet-sending apparatus 100 is shown as being able to use the encryption keys “A”, “B”, and “C”, as well as the decryption keys “a”, “b”, and “c”.

The sequence control format herein is information for distinguishing among SAs. The “List Sequence Format” indicates a format wherein a single SA is established with respect to different QoS priorities, and wherein a different series of sequence numbers is attached for each QoS priority set in the packets. Furthermore, as later described in detail, the “List Sequence Format” is a technique wherein the sequence numbers to be respectively attached are determined for all QoS priorities when establishing an SA for the first time.

The “Independent Sequence Format” and the “Shared-Key Sequence Format” shown in FIG. 4 will be described in Embodiment 2 and Embodiment 3, respectively, and thus their description is omitted at this point.

The data stored in the sender policy storage unit 101 is used by the sender IKE processor 113 when the packet-sending apparatus 100 and the packet-receiving apparatus 200 establish an SA, and is stored in advance by the administrator who manages the packet-sending apparatus 100.

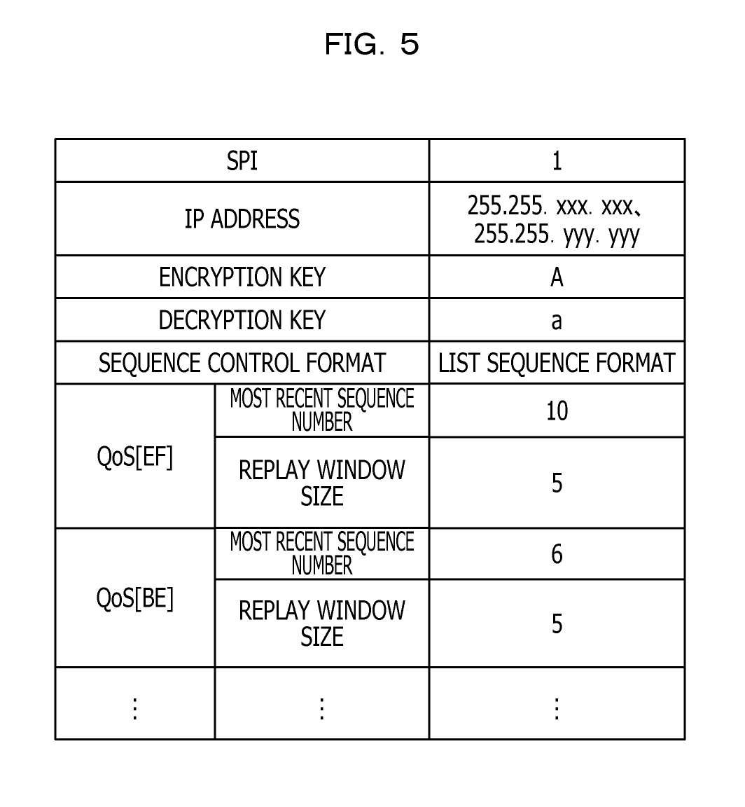

The sender SA storage unit 102 is connected to the sender SA processor 112 and the sender IKE processor 113. As shown in FIG. 5, the sender SA storage unit 102 stores information regarding established SAs. Herein, FIG. 5 is a diagram for explaining an example of information stored in a sender SA storage unit in Embodiment 1.

In the example shown in FIG. 5, the sender SA storage unit 102 stores information in the following fields: “SECURITY PARAMETERS INDEX (SPI)”, “IP ADDRESS”, “ENCRYPTION KEY”, “DECRYPTION KEY” and “SEQUENCE CONTROL FORMAT”. In addition, the sender SA storage unit 102 stores information in a “MOST RECENT SEQUENCE NUMBER” and a “REPLAY WINDOW SIZE” field for each “QoS”.

Among the information stored by the sender SA storage unit 102 herein, the “SPI” is information that uniquely identifies an SA established by the packet-sending apparatus 100 and the packet-receiving apparatus 200. In Embodiment 1, a single SA is established with respect to different QoS priorities, and thus the sender SA storage unit 102 only stores a single “SPI”. In the example shown in FIG. 5, only the SPI “1” is stored.

Among the information stored by the sender SA storage unit 102, the “IP ADDRESS” field corresponds to the Internet Protocol (IP) address of the packet-sending apparatus 100 that acts as the transmission origin in the established SA, as well as the IP address of the packet-receiving apparatus 200 that acts as the transmission destination. In the example shown in FIG. 5, the sender SA storage unit 102 stores “255.255.xxx.xxx, 255.255.yyy.yyy”. Meanwhile, the “ENCRYPTION KEY”, “DECRYPTION KEY”, AND “SEQUENCE CONTROL FORMAT” fields indicate the encryption key, decryption key, and sequence control format used in the established SA. In the example shown in FIG. 5, the encryption key “A”, the decryption key “a”, and the sequence control format “List Sequence Format” are stored.

In addition, among the information stored by the sender SA storage unit 102, the “MOST RECENT SEQUENCE NUMBER” is information for identifying the most recent number among the used sequence numbers, or more specifically, the most recent sequence number among the sequence numbers that have been attached to packets to be sent by the packet-sending apparatus 100. Herein, the series of sequence numbers attached for each QoS priority differs for each QoS priority. Meanwhile, “REPLAY WINDOW SIZE” indicates the replay window size set in the established SA, while “QoS” is information for identifying the QoS priorities.

Herein, the sender SA storage unit 102 respectively stores a “MOST RECENT SEQUENCE NUMBER” and “REPLAY WINDOW SIZE” for all QoS priorities used in the packet transmission system. In other words, in the example shown in FIG. 5, separate “MOST RECENT SEQUENCE NUMBER” and “REPLAY WINDOW SIZE” fields are stored for the QoS “EF” and the QoS “BE” herein given by way of example.

In addition, in Embodiment 1, the sender SA storage unit 102 stores a “MOST RECENT SEQUENCE NUMBER” and a “REPLAY WINDOW SIZE” for all QoS priorities when first establishing an SA with the packet-receiving apparatus 200.

Herein, the data stored in the sender SA storage unit 102 is stored by the sender IKE processor 113 when establishing an SA. Also, the data stored in the sender SA storage unit 102 is used by the sender SA processor 112 when the packet-sending apparatus 100 sends packets, with the “MOST RECENT SEQUENCE NUMBER” being updated every time a packet is sent.

Among the respective units provided in the packet-sending apparatus 100, the sender termination unit 111, the sender SA processor 112, and the sender IKE processor 113 include internal memory for storing programs defining information such as the steps of various sending processes. The sender termination unit 111, the sender SA processor 112, and the sender IKE processor 113 also conduct the various sending processes.

The sender termination unit 111 is connected to the sender SA processor 112, and passes along to the sender SA processor 112 packets that are to be sent to the packet-receiving apparatus 200. For example, in the case where the packet-sending apparatus 100 is connected to other apparatus different from the packet-receiving apparatus 200, the sender termination unit 111 passes along received packets to the sender SA processor 112 when such packets are received from the other apparatus.

The sender SA processor 112 is connected to the sender SA storage unit 102, the sender termination unit 111, and the sender IKE processor 113. The sender SA processor 112 references the sender SA storage unit 102 and sends packets to the packet-receiving apparatus 200 in accordance with an already-established SA.

More specifically, upon receiving a packet from the sender termination unit 111, the sender SA processor 112 references the sender SA storage unit 102 and determines whether or not an SA has been established. For example, the sender SA processor 112 may determine whether or not information regarding an already-established SA is being stored in the sender SA storage unit 102.

If it is determined that an SA has been established, then the sender SA processor 112 sends packets to the packet-receiving apparatus 200 in accordance with the already-established SA. More specifically, the sender SA processor 112 encrypts packets set with different QoS priorities using the same encryption key, attaches a different series of sequence numbers for each QoS priority set in the packets, and then sends the packets. For example, the sender SA processor 112 may attach a different series of sequence numbers in ascending order for each QoS priority set in the packets, and then send the packets.

If it is determined than an SA has not been established, then the sender SA processor 112 passes along information indicating the above to the sender IKE processor 113. Thereafter, upon receiving information indicating that an SA has been established by the sender IKE processor 113, the sender SA processor 112 sends packets to the packet-receiving apparatus 200 in accordance with the established SA.

The sender IKE processor 113 is connected to the sender policy storage unit 101, the sender SA storage unit 102, and the sender SA processor 112. Upon receiving information from the sender SA processor 112 indicating that the sender SA processor 112 has determined that an SA has not been established, the sender IKE processor 113 establishes an SA with the packet-receiving apparatus 200 that acts as the transmission destination to which packets are to be sent. In other words, the sender IKE processor 113 cooperates with the receiver IKE processor 211 (hereinafter described) in the packet-receiving apparatus 200 to establish an SA between the packet-sending apparatus 100 and the packet-receiving apparatus 200.

In Embodiment 1, the sender IKE processor 113 cooperates with the receiver IKE processor 211 to establish a single SA with respect to different QoS priorities.

When establishing an SA, the sender IKE processor 113 and the receiver IKE processor 211 negotiate by sending and receiving Internet Key Exchange (IKE) packets, and determine the encryption key, decryption key, and sequence control format to be used in the SA.

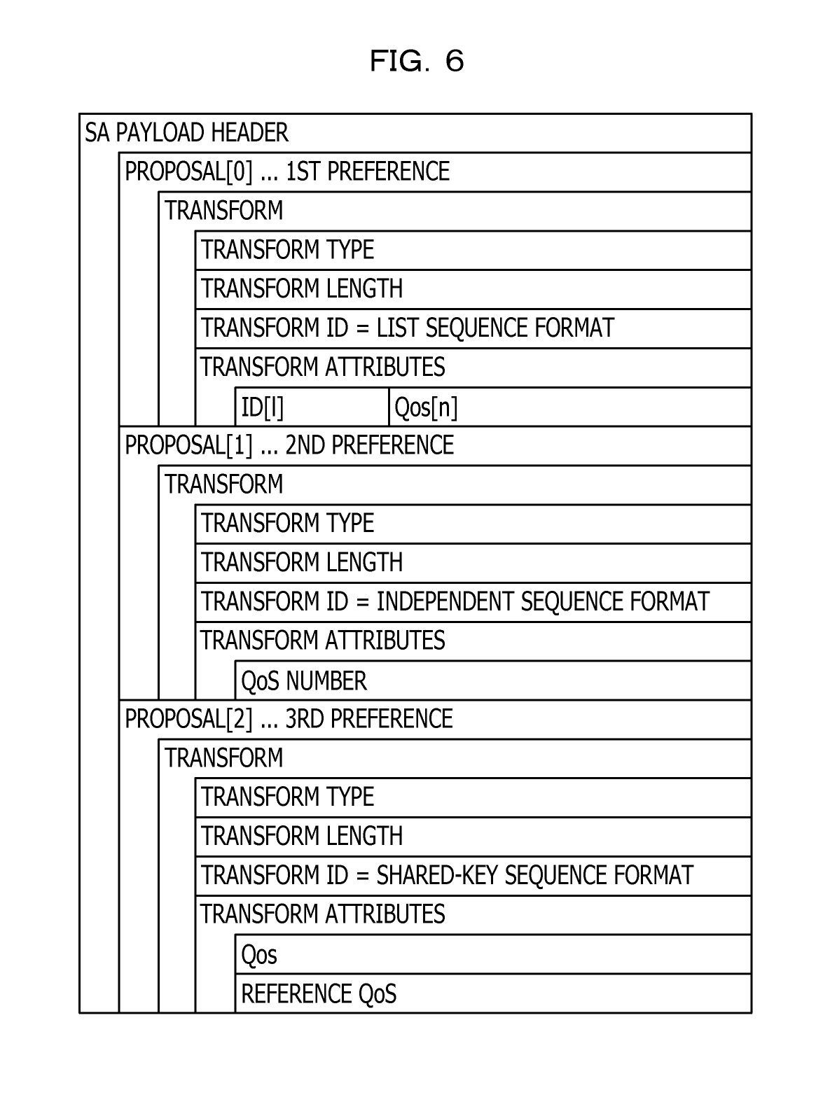

An example of an IKE packet will now be described using FIG. 6. The example shown in FIG. 6 is the header of the payload contained in an IKE packet. The example shown in FIG. 6 illustrates the case wherein the sender IKE processor 113 makes three proposals regarding the sequence control format to the packet-receiving apparatus 200. The example shown in FIG. 6 herein relates to Internet Key Exchange version 2 (IKEv2). Also, although only information related to the sequence control format is included in the example shown in FIG. 6, other information relevant to negotiation and used to establish an SA, such as encryption keys and decryption keys, may also be included.

In the IKE packet shown in FIG. 6, each proposal contains the following fields: “TRANSFORM TYPE”, “TRANSFORM LENGTH”, “TRANSFORM ID”, and “TRANSFORM ATTRIBUTES”. Furthermore, the proposals are defined in order of preference. Herein, the “TRANSFORM TYPE” field contains information for identifying a sequence control format. For example, a number between 6 and 255 may be set, wherein a particular sequence control format is associated with the number set in the “TRANSFORM TYPE” field. The “TRANSFORM LENGTH” field contains the length of the transform field.

The “TRANSFORM ID” field contains the title of the sequence control format. For example, the title “List Sequence Format” may be set. The “TRANSFORM ATTRIBUTES” field contains information corresponding to the sequence control format. For example, in the case of the List Sequence Format, combinations of QoS priorities and sequence numbers may be set. Herein, transform attributes for cases other than that of the List Sequence format are described after Embodiment 1, and thus their description is omitted at this point.

[Configuration of Packet-Receiving Apparatus]

The packet-receiving apparatus 200 is connected to the packet-sending apparatus 100 via the network 300, and is provided with a receiver policy storage unit 201, a receiver SA storage unit 202, a receiver IKE processor 211, a receiver SA processor 212, and a receiver termination unit 213.

Among the respective units provided in the packet-receiving apparatus 200, the receiver policy storage unit 201 and the receiver SA storage unit 202 store data used for various receiving processes executed by the packet-receiving apparatus 200. The receiver policy storage unit 201 corresponds to the sender policy storage unit 101, and stores information similar to that of the sender policy storage unit 101. The receiver SA storage unit 202 corresponds to the sender SA storage unit 102, and stores information similar to that of the sender SA storage unit 102.

The differences between the receiver policy storage unit 201 and the receiver SA storage unit 202 in the packet-receiving apparatus 200 and the sender policy storage unit 101 and sender SA storage unit 102 in the packet-sending apparatus 100 will now be simply described. The above storage units differ in that, while the receiver policy storage unit 201 and the receiver SA storage unit 202 store information regarding the packet-receiving apparatus 200, the sender policy storage unit 101 and the sender SA storage unit 102 store information regarding the packet-sending apparatus 100.

The receiver SA storage unit 202 stores, for each priority, a history of the sequence numbers attached to packets received from the packet-sending apparatus 100. In addition, the receiver SA storage unit 202 stores information using a data structure that is similar to the example illustrated in FIG. 5 that was given as an example of the sender SA storage unit 102. The history in the receiver SA storage unit 202 corresponds to the “MOST RECENT SEQUENCE NUMBER” in the example illustrated in FIG. 5 that was given as an example of the sender SA storage unit 102. In other words, the “MOST RECENT SEQUENCE NUMBER” stored by the receiver SA storage unit 202 corresponds to the largest sequence number among the sequence numbers attached packets received by the packet-receiving apparatus 200.

Among the respective units provided in the packet-receiving apparatus 200, the receiver termination unit 213, the receiver SA processor 212, and the receiver IKE processor 211 include internal memory for storing programs defining information such as the steps of various receiving processes. The receiver termination unit 213, the receiver SA processor 212, and the receiver IKE processor 211 also conduct the various receiving processes.

The receiver IKE processor 211 is connected to the receiver policy storage unit 201 and the receiver SA storage unit 202. The receiver IKE processor 211 cooperates with the sender IKE processor 113 to establish an SA with the packet-sending apparatus 100. The receiver IKE processor 211 then stores information regarding the established SA in the receiver SA storage unit 202. Other features of the receiver IKE processor 211 are similar to those of the sender IKE processor 113, and thus their description is herein omitted.

The receiver SA processor 212 is connected to the receiver SA storage unit 202 and the receiver termination unit 213, and is additionally connected to the sender SA processor 112 via the network 300. Upon receiving packets sent by the sender SA processor 112, the receiver SA processor 212 performs a replay attack check using sequence numbers in accordance with an SA that has already been established by the receiver IKE processor 211.

More specifically, the receiver SA processor 212 identifies the sequence numbers attached to the received packets. The receiver SA processor 212 then cross-references the sequence numbers with the history stored in the receiver SA storage unit 202 in association with the QoS priorities set in the received packets. In so doing, the receiver SA processor 212 determines whether or not they received packets have been previously received.

At this point, if it is determined that the packets have not been previously received, then the receiver SA processor 212 decrypts packets set with different QoS priorities using the same decryption key. Subsequently, the receiver SA processor 212 passes along the decrypted packets to the receiver termination unit 213. The receiver SA processor 212 also updates the history stored in the receiver SA storage unit 202, or more specifically, updates the most recent sequence number. In contrast, if it is determined that the packets have been previously received, then the receiver SA processor 212 discards the packets.

The receiver termination unit 213 is connected to the receiver SA processor 212. The receiver termination unit 213 receives packets from the sender SA processor 112, and transmits packets received by the packet-receiving apparatus 200 to other apparatus that will make use of such packets.

[Processes Executed by Packet Transmission System in Accordance with Embodiment 1]

The flows of processes executed by a packet transmission system in accordance with Embodiment 1 will now be described. Hereinafter, the following will be described in order: the flow of process for establishing an SA in the packet transmission system, the flow of a packet sending process executed by the packet-sending apparatus 100, and the flow of a packet receiving process executed by the packet-receiving apparatus 200.

[SA Establishment Process in Packet Transmission System in Accordance with Embodiment 1]

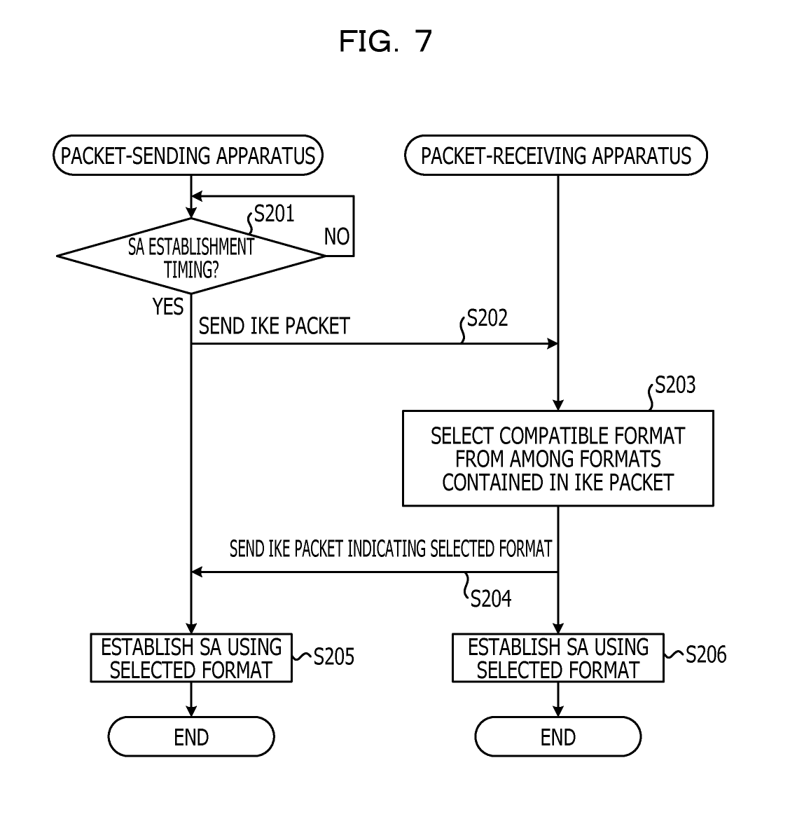

FIG. 7 will now be used to describe the flow of an SA establishment process in a packet transmission system in accordance with Embodiment 1. Herein, FIG. 7 is a sequence diagram for explaining the flow of an SA establishment process in a packet transmission system in Embodiment 1.

As shown in FIG. 7, the process to establish an SA is initiated when the timing for establishing an SA is reached in the packet-sending apparatus 100 (step S201: Yes). For example, the process may be initiated when it is determined by the sender SA processor 112 that an SA has not been established when sending a packet. More specifically, the sender IKE processor 113 sends an IKE packet like that shown in FIG. 6 to the packet-receiving apparatus 200 (step S202).

At this point, the sender IKE processor 113 uses an IKE packet to send to the receiver IKE processor 211 information regarding the encryption keys, decryption keys, and sequence control formats preferred for use in subsequently establishing an SA. In addition, the encryption keys, decryption keys, and sequence control formats sent using the IKE packet are set in order of preference. It should be appreciated that the sender IKE processor 113 does not send encryption keys and decryption keys themselves, but rather sends information for uniquely identifying encryption keys and decryption keys.

For example, in the example shown in FIG. 6, the sender IKE processor 113 has set “List Sequence Format” in the “TRANSFORM ID” field of the first preference, proposal [0]. Furthermore, in the case where “List Sequence Format” is set, the sender IKE processor 113 also sets combinations of QoS priorities and sequence numbers in the “TRANSFORM ATTRIBUTES” field of the IKE packet. For example, in the case where the QoS priorities “EF” and “BE” are used, the sender IKE processor 113 sets the QoS priorities “EF” and “BE”.

At this point, the sender IKE processor 113 respectively sets all QoS priorities used in the packet transmission system in the “TRANSFORM ATTRIBUTES” field. When establishing an SA, the sender IKE processor 113 sends to the packet-receiving apparatus all priority identification (ID) information indicating the individual QoS priorities set in packets to be sent from the packet-sending apparatus. Herein, such priority ID information may correspond to “EF” and “BE”, for example.

Subsequently, the receiver IKE processor 211 in the packet-receiving apparatus 200 selects one format compatible with the packet-receiving apparatus 200 from among the formats contained in the IKE packet (step S203). For example, starting from the proposals ranked high in order of preference, the receiver IKE processor 211 may determine whether or not the sequence control format is compatible with the packet-receiving apparatus 200, and select the first sequence control format determined to be compatible. For example, in the example shown in FIG. 6, the receiver IKE processor 211 selects the “List Sequence Format” of proposal [0].

In addition, the receiver IKE processor 211 selects an encryption key and a decryption key in a manner similar to selecting the sequence control format.

Subsequently, the receiver IKE processor 211 in the packet-receiving apparatus 200 sends to the sender IKE processor 113 an IKE packet indicating the selected format (step S204).

Subsequently, the sender IKE processor 113 in the packet-sending apparatus 100 establishes an SA using the format specified by the IKE packet received from the receiver IKE processor 211 (step S205). Also, at this point the sender IKE processor 113 stores information regarding the established SA in the sender SA storage unit 102.

Described with reference to the example shown in FIG. 5, the sender IKE processor 113 first sets an SPI, and then stores information in the “IP ADDRESS”, “ENCRYPTION KEY”, and “SEQUENCE CONTROL FORMAT” fields in the sender SA storage unit 102. In addition, for each QoS priority used in the packet transmission system, the sender IKE processor 113 stores information in the “MOST RECENT SEQUENCE NUMBER”, “REPLAY WINDOW”, and “QoS” fields in the sender SA storage unit 102.

Among the information stored by the sender IKE processor 113 in the sender SA storage unit 102 at this point, the information stored in the “ENCRYPTION KEY”, “SEQUENCE CONTROL FORMAT”, “REPLAY WINDOW”, and “QoS” fields is identified by the IKE packet. Since sequence numbers have not yet been used at the time of establishing a new SA, the “MOST RECENT SEQUENCE NUMBER” field is set to a default value of 0.

Similarly to the sender IKE processor 113, the receiver IKE processor 211 likewise establishes an SA using the format selected from among the formats specified by the received IKE packet (step S206). At this point, the receiver IKE processor 211 also stores information regarding the established SA in the receiver SA storage unit 202, and configures the receiver SA storage unit 202 to store a history of sequence numbers for each set of priority ID information sent by the sender IKE processor 113.

[Packet Sending Process Executed by Packet-Sending Apparatus in Embodiment 1]

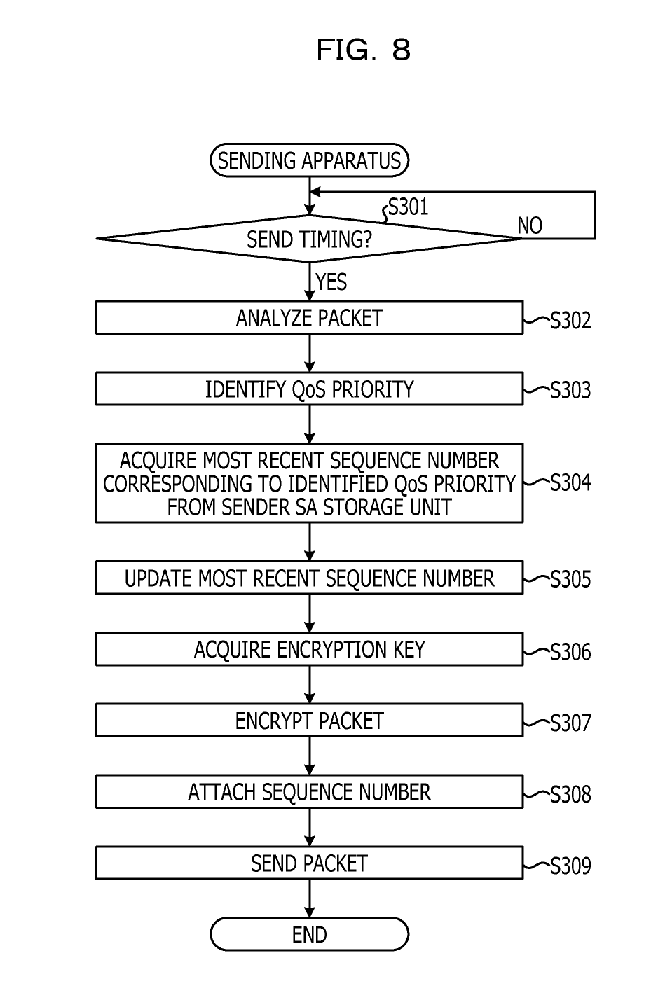

FIG. 8 will now be used to describe the flow of a packet sending process executed by the packet-sending apparatus 100 in Embodiment 1. Herein, FIG. 8 is a flowchart for explaining the flow of a packet sending process conducted by a packet-sending apparatus in Embodiment 1.

Since the flow of the process for establishing an SA has been described using FIG. 7, the flow of the packet sending process will be hereinafter described for the case where an SA has been established in advance. Also, unless otherwise stated, the flow of the packet sending process executed by a packet-sending apparatus in Embodiment 1 will be described for the exemplary case wherein the QoS priority “BE” is set in the packets to be sent.

As shown in FIG. 8, once the sending timing is reached in the packet-sending apparatus 100 (step S301: Yes), the sender SA processor 112 analyzes a packet to be sent (step S302), and identifies the QoS priority set in the packet (step S303). In this example, the sender SA processor 112 identifies the QoS priority “BE” as being set in the packet.

Subsequently, the sender SA processor 112 acquires the most recent sequence number corresponding to the identified QoS priority from the sender SA storage unit 102 (step S304). Described with reference to the example shown in FIG. 5, the sender SA processor 112 acquires the most recent sequence number “6” corresponding to the QoS priority “BE”.

The sender SA processor 112 then updates the most recent sequence number (step S305). Described with reference to the example shown in FIG. 5, the sender SA processor 112 updates the most recent sequence number corresponding to the QoS priority “BE” from “6” to “7”.

Subsequently, the sender SA processor 112 acquires an encryption key from the sender SA storage unit 102 (step S306). Described with reference to the example shown in FIG. 5, the sender SA processor 112 acquires the encryption key “A”. The sender SA processor 112 then encrypts the packet to be sent (step S307). For example, the sender SA processor 112 may encrypt the packet to be sent using the encryption key “A”, regardless of the QoS priority set in the packet.

Subsequently, the sender SA processor 112 attaches a sequence number to the packet (step S308). The sequence number at this point is part of a series that differs for each QoS priority set in the packets. For example, the sender SA processor 112 may attach the most recently updated sequence number “7” to the packet set with the QoS priority “BE”. If, for example, the QoS priority set in the packet to be sent at this point is “EF”, then a sequence number corresponding to the QoS priority “EF” is attached. In the example shown in FIG. 5, the next number after “10” (i.e., “11”) is attached.

The sender SA processor 112 then sends the packet to the packet-receiving apparatus 200 (step S309). In other words, the sender SA processor 112 uses the same encryption key to encrypt packets set with different QoS priorities, attaches a different series of sequence numbers for each QoS priority set in the packets, and then sends the packets.

[Packet Receiving Process Executed by Packet-Receiving Apparatus in Embodiment 1]

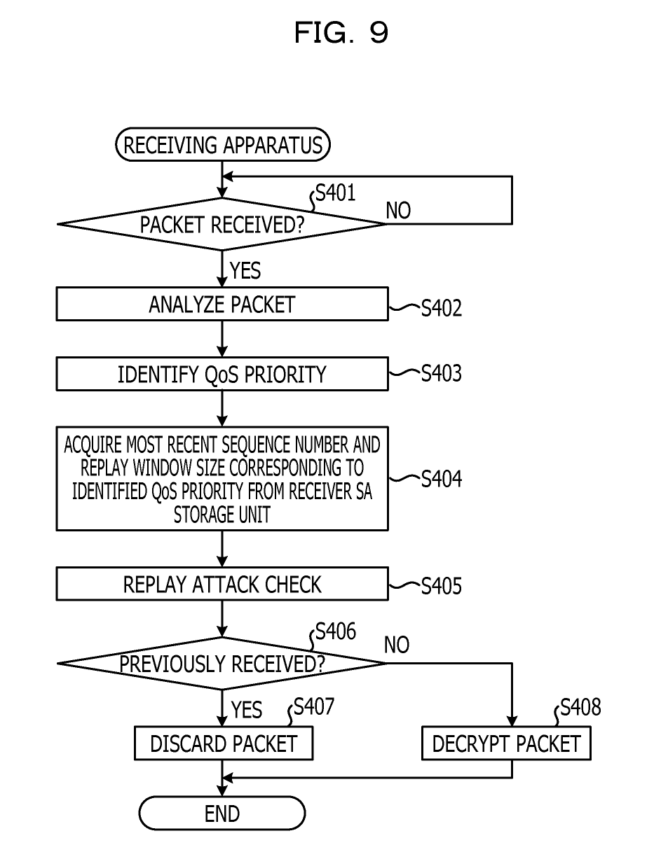

FIG. 9 will now be used to describe the flow of a packet receiving process executed by the packet-receiving apparatus 200 in Embodiment 1. Herein, FIG. 9 is a flowchart for explaining the flow of a packet receiving process conducted by a packet-receiving apparatus in Embodiment 1. Also, unless otherwise stated, the flow of the packet receiving process executed by the packet-receiving apparatus 200 in Embodiment 1 will be described for the exemplary case wherein the QoS priority “BE” is set in the received packets.

As shown in FIG. 9, upon receiving a packet (step S401: Yes), the receiver SA processor 212 in the packet-receiving apparatus 200 analyzes the received packet (step S402), and identifies the QoS priority set in the packet (step S403). For example, the receiver SA processor 212 may identify the QoS priority set in the received packet as being “BE”.

Subsequently, the receiver SA processor 212 acquires from the receiver SA storage unit 202 the most recent sequence number and the replay window size corresponding to the identified QoS priority (step S404). For example, the receiver SA processor 212 may acquire the most recent sequence number “6” and the replay window size “3”, which correspond to the QoS priority “BE”.

Herein, the receiver SA storage unit 202 stores the most recent sequence number for each QoS priority, while the receiver SA processor 212 acquires a most recent sequence number that is different for each QoS priority.

Using the sequence numbers that differ for each QoS priority, the receiver SA processor 212 performs a replay attack check (step S405). More specifically, the receiver SA processor 212 first identifies the sequence number attached to the received packet. The receiver SA processor 212 then cross-references the history stored in the receiver SA storage unit 202 in association with the QoS priority set in the received packet to determine whether or not the received packet has been previously received.

The above will be further described, taking by way of example the case of making a determination using the most recent sequence number “6” and the replay window size “3”. If the identified sequence number is larger than the most recent sequence number (i.e., “7” or greater, in this example), then the receiver SA processor 212 determines that the packet has not been previously received. If the identified sequence number is “6”, then the identified sequence number duplicates a sequence number that has been already received, and thus the receiver SA processor 212 determines that the packet has been previously received. If the identified sequence number is less than “6” but is also a sequence number falling within the replay window size “3”, then the receiver SA processor 212 determines that the packet has not been previously received. For example, if the identified sequence number is “4”, “5”, or “6”, then the receiver SA processor 212 determines that the packet has not been previously received. However, among the sequence numbers “4”, “5”, and “6”, the sequence number “6” is stored as the most recent sequence number, and as described above, a packet with the sequence number “6” is first determined to have been previously received. If the identified sequence number is less than “6” and also falls outside the replay window size “3”, then the receiver SA processor 212 determines the packet to have been previously received. For example, if the sequence number is equal to or “3”, then the receiver SA processor 212 determines that the packet has been previously received.

The reason why a packet with a sequence number of “4” or “5” is not determined to have been previously received will now be simply explained. The order in which packets are sent by the packet-sending apparatus 100 and the order in which packets are received by the packet-receiving apparatus 200 might not be the same, and the order of some packets might be switched. In order to prevent the invalid discarding of packets in such cases, a replay window is used. As a result, in the example described above, a packet with a sequence number of “4” or “5” is determined to not have been previously received.

If the packet is determined to have been previously received (step S406: Yes), then the receiver SA processor 212 discards the received packet (step S407). In other words, the receiver SA processor 212 discards the received packet if, for example, its sequence number duplicates the most recent sequence number, or if its sequence number is determined to be outside the replay window size. In contrast, if the packet is determined to not have been previously received (step S406: No), then the receiver SA processor 212 decrypts the received packet (step S408). In other words, the receiver SA processor 212 decrypts the received packet if, for example, its sequence number is larger than the most recent sequence number, or if its sequence number is determined to be within the replay window size. In other words, the receiver SA processor 212 uses the same decryption key to decrypt packets set with different QoS priorities. In the example shown in FIG. 5, the receiver SA processor 212 decrypts packets using the decryption key “a”. In addition, the receiver SA processor 212 stores the most recent sequence number in the receiver SA storage unit 202.

### Advantages of Embodiment 1

Thus, according to Embodiment 1, the packet-sending apparatus 100 uses the same encryption key to encrypt packets set with different QoS priorities, attaches a different series of sequence numbers for each QoS priority set in the packets, and then sends the packets. In addition, the packet-receiving apparatus 200 is provided with a receiver SA storage unit 202 that stores a per-priority history of the sequence numbers attached to received packets. The packet-receiving apparatus 200 identifies the sequence number attached to a received packet, and by cross-referencing the history associated with the QoS priority set in the received packet, determines whether or not the received packet has been previously received. If the packet is determined to not have been previously received, then the packet-receiving apparatus 200 decrypts the packet. Herein, the packet-receiving apparatus 200 uses the same decryption key to decrypt packets set with different QoS priorities.

As a result, according to Embodiment 1, it becomes possible to suitably realize a replay attack check. More specifically, since the same cryptographic keys are used for a plurality of QoS priorities, the number of cryptographic keys is kept to a minimum. Furthermore, since checks are conducted using different sequence numbers for each priority, it is possible to prevent the invalid discarding of packets that may occur as a result of inversions in the packet receive order due to priority differences.

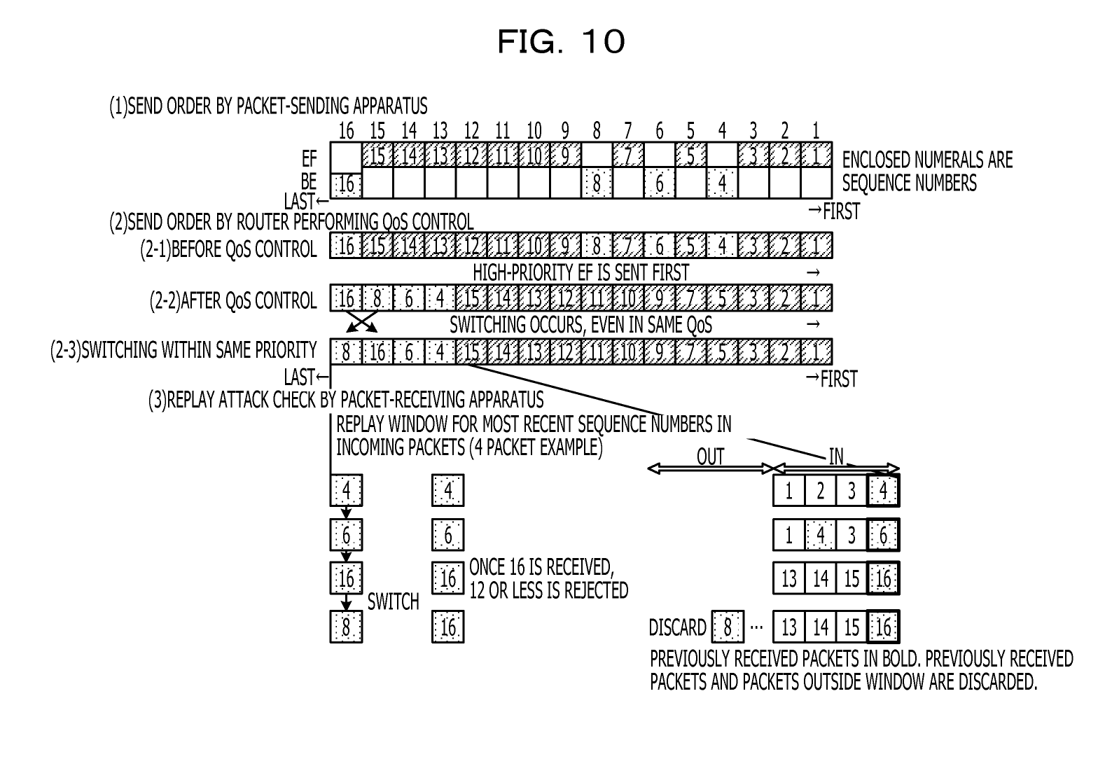

FIG. 10 will now be used to describe the advantage that enables the invalid discarding of packets to be prevented. Herein, FIG. 10 is a diagram for explaining advantages obtained by a packet transmission system in Embodiment 1.

For example, in techniques of the related art, a packet-sending apparatus may attach sequence numbers in the transmission order, regardless of the QoS priority. In the example indicated (1) in FIG. 10, the sequence numbers 1 to 3, 5, 7, and 9 to 15 are attached with respect to the QoS priority “EF”. Similarly, the packet-sending apparatus 100 attaches the sequence numbers 4, 6, 8, and 16 with respect to the QoS priority “BE”.

Herein, packets sent by the packet-sending apparatus arrive at the packet-receiving apparatus after passing through a router or similar apparatus that conducts transmission control by means of QoS. In this case, the packet transmission order is updated in the router, as shown at (2) in FIG. 10. In other words, the router prioritizes packets set with a relatively high QoS priority over packets set with a relatively low QoS priority. As a result, the packets are sent in a transmission order that differs from the transmission order established by the packet-sending apparatus 100. For example, in the example indicated by “BEFORE QoS CONTROL” at (2-1) in FIG. 10, packets are arranged in the same transmission order as that sent by the packet-sending apparatus 100. In contrast, that order has changed in the example indicated by “AFTER QoS CONTROL” at (2-2) in FIG. 10. Since the QoS priority “EF” has a higher priority than “BE”, packets set with the QoS priority “EF” are placed earlier in the transmission order than packets set with the QoS priority “BE”, regardless of the magnitude of their respective sequence numbers.

As a result, in the case where the packet-receiving apparatus receives packets in the transmission order indicated at (2-2) in FIG. 10, the packet with the attached sequence number “4” is received after the packet with the attached sequence number “15”. Given a replay window size of “4”, a packet-receiving apparatus adopting the techniques of the related art would at this point determine that the packet with the attached sequence number “4” has been previously received. In addition, the packet-receiving apparatus would determine that the packet with the attached sequence number “8” is outside the replay window, and thus discard the packet. In other words, invalid discarding of packets occurs as a result of inversions in the packet receive order due to QoS priority differences.

Furthermore, the transmission order might be switched during the packet transmission process, even for packets with the same QoS priority. In the example indicated by “INVERSION WITHIN SAME PRIORITY” at (2-3) in FIG. 10, the transmission order has been switched between packets set with the QoS priority “BE”. As a result, in the case where a packet-receiving apparatus adopting the techniques of the related art receives packets in the transmission order indicated at (2-3) in FIG. 10, the packet-receiving apparatus will receive the packet with the attached sequence number “8” after the packet with the attached sequence number “16”. For this reason, when given a replay window size of “4”, the packet-receiving apparatus 200 will discard the packet with the attached sequence number “8”, as indicated by “REPLAY ATTACK CHECK EXECUTED BY PACKET-RECEIVING APPARATUS” at (3) in FIG. 10. In other words, invalid discarding of packets occurs as a result of order inversions within the same priority.

In contrast, according to Embodiment 1, a different series of sequence numbers is attached for each QoS priority. For this reason, it is possible to prevent the invalid discarding of packets that may occur as a result of inversions in the packet receive order due to QoS priority differences, as well as the invalid discarding of packets that may occur as a result of order inversions within the same priority.

Furthermore, according to Embodiment 1, the packet-sending apparatus 100 establishes a single SA with the packet-receiving apparatus 200 for different QoS priorities. When establishing the SA, the packet-sending apparatus 100 sends to the packet-receiving apparatus 200 priority ID information that indicates the QoS priorities set in the packets to be sent from the packet-sending apparatus 100. Upon receiving the priority ID information, the packet-receiving apparatus 200 stores the priority ID information in the receiver SA storage unit 202, and configures the receiver SA storage unit 202 to store a history of sequence numbers for each set of priority ID information.

As a result, according to Embodiment 1, respectively different series of sequence numbers are set for all QoS priorities used in the packet transmission system. For this reason, it is possible to realize strict settings when establishing an SA.

In this way, according to Embodiment 1, it is possible to execute replay attack checks without increasing SA resources, even on networks using routers or security equipment that do not guarantee identical send and receive packet orders for packets set with the same QoS priority. As a result, it becomes possible to provide a high-security network at low cost. In particular, wireless network systems involve networks between adjacent nodes and QoS combinations arranged in a mesh configuration. For this reason, the number of SA resources is large. In the techniques of the related art, many devices and expensive components were adopted in order to realize the large number of SA resources. In contrast, Embodiment 1 makes it possible to achieve significant advantages by reducing the many devices and expensive components that have been adopted in the related art.

Moreover, Embodiment 1 makes it possible to establish an SA for all QoS priorities at once.

### Embodiment 2

In the foregoing, Embodiment 1 is described as involving a technique wherein, when establishing an SA, the packet-sending apparatus 100 sends all priority ID information indicating the QoS priorities used in the packet-sending apparatus 100. In addition, another technique is described wherein, when establishing an SA, the packet-receiving apparatus 200 respectively stores a combination of a QoS priority and a series of sequence numbers in the receiver SA storage unit 202 for all QoS priorities.

However, the present invention is not limited to the above, and the packet-sending apparatus 100 may also send just the number of QoS priorities. When establishing an SA, the packet-receiving apparatus 200 may then ascertain just the number of QoS priorities. Subsequently, the packet-receiving apparatus 200 may analyze received packets, identify combinations of QoS priorities and series of sequence numbers, and store the resulting information in the receiver SA storage unit 202.

Therefore, a technique will be described hereinafter as Embodiment 2, wherein just the number of QoS priorities is sent when establishing an SA.

More specifically, a technique will be described wherein a single SA is established for different QoS priorities, and wherein the packet-sending apparatus 100 sends just the number of QoS priorities. Also, a technique will be described wherein, in the case where the priority ID information that indicates the QoS priorities set in incoming packets is not stored in the receiver SA storage unit 202, the packet-receiving apparatus 200 configures the receiver SA storage unit 202 to store a history of sequence numbers in association with the priority ID information. The techniques described in Embodiment 2 correspond to the sequence control format herein referred to as the “Independent Sequence Format”.

Hereinafter, features that are similar to those of a packet transmission system in accordance with Embodiment 1 will either be described briefly, or their description will be omitted.

[Configuration of Packet-Sending Apparatus and Packet-Receiving Apparatus in Embodiment 2]

The sender IKE processor 113 and the receiver IKE processor 211 in Embodiment 2 cooperate to establish a single SA with respect to different QoS priorities. At this point, the sender IKE processor 113 sends an IKE packet set with the number of individual QoS priorities. Described with reference to the example shown in FIG. 6, the QoS number indicating the number of QoS priorities is set in the “TRANSFORM ATTRIBUTES” field of the IKE packet. For example, in the case where the packet-sending apparatus 100 uses “EF” and “BE” as the QoS priorities, the sender IKE processor 113 sets the QoS number “2”.

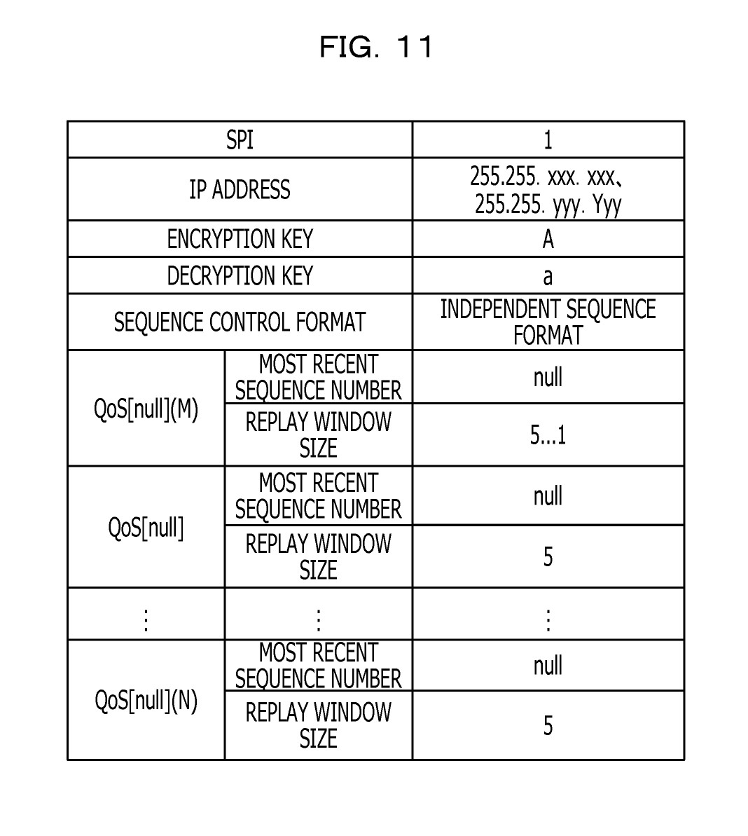

In addition, the receiver IKE processor 211 uses the IKE packet from the sender IKE processor 113 to store information regarding the established SA in the receiver SA storage unit 202. When establishing an SA at this point, the receiver IKE processor 211 has not ascertained what QoS priorities are in use by the packet-sending apparatus 100, and instead ascertains just the QoS number. For this reason, in the receiver SA storage unit 202, no information is stored in the respective “QoS” fields, and similarly, no information is stored in the “MOST RECENT SEQUENCE NUMBER” fields, as shown in FIG. 11. Stated differently, the receiver IKE processor 211 prepares a number of blank records in the receiver SA storage unit 202 equal to the QoS number. These blank records will then be used to store the most recent sequence number for each QoS. Meanwhile, the information in the “SPI”, “IP ADDRESS”, “ENCRYPTION KEY”, “DECRYPTION KEY”, and “REPLAY WINDOW SIZE” fields is similar to that of Embodiment 1, and further description thereof is herein omitted. Herein, the example shown in FIG. 11 illustrates the case wherein the QoS number is “n”. FIG. 11 is a diagram for explaining an example of information stored in a receiver SA storage unit in Embodiment 2.

Upon receiving a packet from the packet-sending apparatus 100 after an SA has been established, the receiver SA processor 212 in Embodiment 2 identifies the QoS priority set in the received packet. The receiver SA processor 212 then performs a search to determine whether or not priority ID information indicating the identified QoS priority is stored in the receiver SA storage unit 202.

For example, in the case where the QoS priority “EF” is set in the received packet, the receiver SA processor 212 performs a search to determine whether or not a “QoS” field exists with the value “EF”.

If the receiver SA processor 212 obtains a search result indicating that such information is not being stored, then the receiver SA processor 212 sends information indicating the above to the receiver IKE processor 211. Subsequently, the receiver IKE processor 211 stores in the receiver SA storage unit 202 priority ID information indicating the QoS priority that was identified by the receiver SA processor 212, and configures the receiver SA storage unit 202 to store a history of sequence numbers in association with the priority ID information.

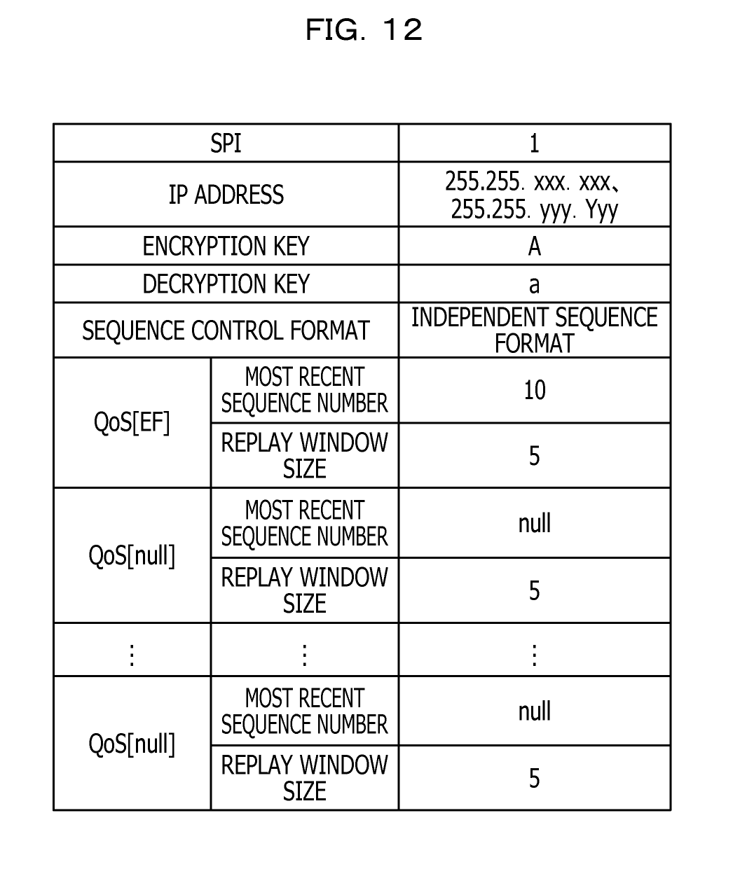

More specifically, the receiver IKE processor 211 appends a “QoS” field to one of the blank records provided in the receiver SA storage unit 202, and stores the identified QoS priority therein. For example, in the example shown in FIG. 12, the receiver IKE processor 211 stores the QoS priority “EF” in the field “QoS null (1)”. Subsequently, the receiver IKE processor 211 initializes the “MOST RECENT SEQUENCE NUMBER” field associated with the QoS “EF”, storing the value “0”, for example. Herein, FIG. 12 is a diagram for explaining an example of information stored in a receiver SA storage unit in Embodiment 2.

In other words, as shown in FIG. 11, the receiver IKE processor 211 does not store any information in the “MOST RECENT SEQUENCE NUMBER” and “QoS” fields when establishing an SA, but instead stores the QoS priority for a received packet in the “QoS” field, as shown in FIG. 12.

In so doing, the receiver IKE processor 211 stores a new QoS priority in the receiver SA storage unit 202 every time the packet-receiving apparatus 200 receives a packet set with a QoS priority not stored in the receiver SA storage unit 202.

Returning to the description of the receiver SA processor 212, upon obtaining a search result indicating that priority ID information indicating the identified QoS priority is stored in the receiver SA storage unit 202, the receiver SA processor 212 performs a replay attack check by referencing the receiver SA storage unit 202.

[Process Executed by Packet-Receiving Apparatus in Embodiment 2]

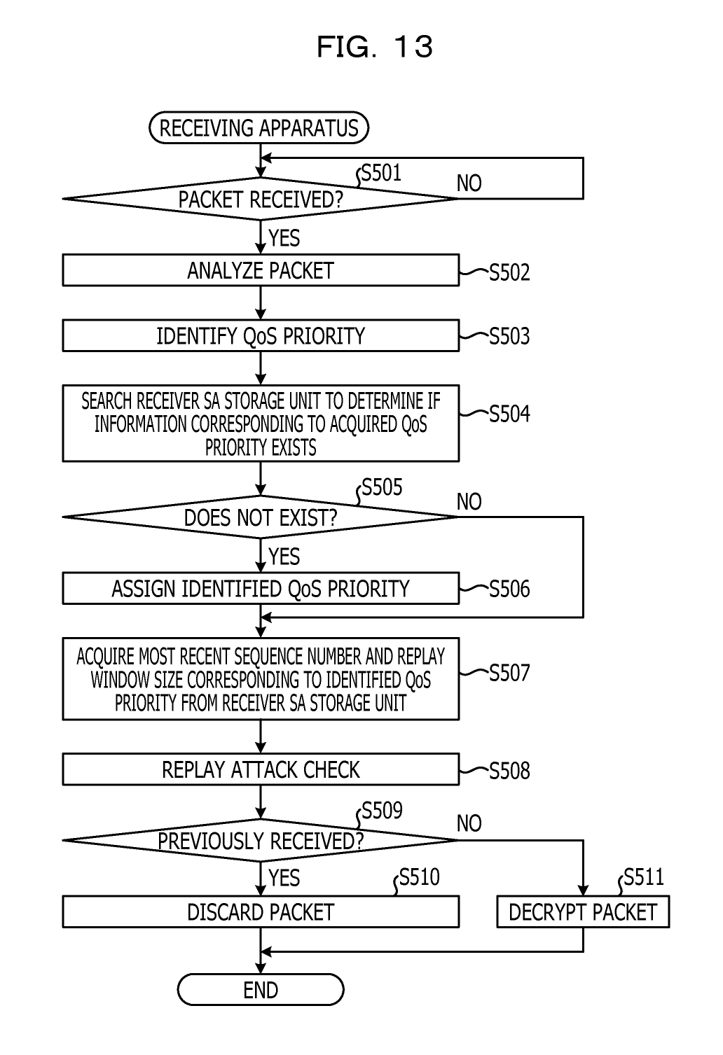

FIG. 13 will now be used to describe the flow of a packet receiving process executed by the packet-receiving apparatus 200 in Embodiment 2. Herein, FIG. 13 is a flowchart for explaining the flow of a packet receiving process conducted by a packet-receiving apparatus in Embodiment 2. Since the flow of the process executed by the packet-sending apparatus 100 in Embodiment 2 is similar to that of the packet-sending apparatus 100 in Embodiment 1, further description thereof is herein omitted.

Among the steps of the process shown in FIG. 13, steps S501 to S503 respectively correspond to steps S401 to S403 in FIG. 9. Also, steps S507 to S511 respectively correspond to steps S404 to S408 in FIG. 9. In other words, the process executed by the packet-receiving apparatus 200 in Embodiment 2 involves the process executed by the packet-receiving apparatus 200 in Embodiment 1, with the addition of steps S504 to S506 in FIG. 13.

As shown in FIG. 13, upon receiving a packet (step S501: Yes), the receiver SA processor 212 of the packet-receiving apparatus 200 in Embodiment 2 analyzes the received packet and identifies the QoS priority (step S502, step S503).

Subsequently, the receiver SA processor 212 searches the receiver SA storage unit 202 to determine whether or not there exists information corresponding to the acquired QoS priority (step S504). In other words, the receiver SA processor 212 performs a search to determine whether or not priority ID information indicating the acquired QoS priority is being stored. For example, in the case where the QoS priority “EF” is set in the received packet, the receiver SA processor 212 performs a search to determine whether or not a “QoS” field exists with the value “EF”.

At this point, if the QoS priority set in the received packet does not exist in the receiver SA storage unit 202 (step S505: Yes), then the identified QoS priority is stored in a blank record (step S506). For example, the receiver IKE processor 211 may store the QoS priority “EF” in the field “QoS null (1)”, and initialize the “MOST RECENT SEQUENCE NUMBER” field by storing “0” therein. Subsequently, the receiver SA processor 212 executes the processing in step S507 and thereafter.

In contrast, if it is determined that information corresponding to the QoS priority set in the received packet does exist in the receiver SA storage unit 202 (step S505: No), or in other words, if the receiver SA processor 212 obtains a search result indicating that such information is being stored, then the receiver IKE processor 211 executes the processing in step S507 and thereafter without executing the above step S506.

### Advantages of Embodiment 2

As described above, according to Embodiment 2, the packet-sending apparatus 100 establishes a single SA with respect to different QoS priorities. Subsequently, upon receiving a packet from the packet-sending apparatus 100 after an SA has been established, the packet-receiving apparatus 200 identifies the QoS priority set in the received packet. The packet-receiving apparatus 200 then performs a search to determine whether or not priority ID information indicating the identified QoS priority is being stored in the receiver SA storage unit 202. If the packet-receiving apparatus 200 obtains a search result indicating that such information is not being stored, then the packet-receiving apparatus 200 stores priority ID information indicating the identified QoS priority in the receiver SA storage unit 202, and configures the receiver SA storage unit 202 to store a history of sequence numbers in association with the stored priority ID information.

As a result, the receiver SA storage unit 202 can be configured in response to the priorities set in transmitted packets, without specifying all QoS priorities when establishing an SA. Thus, it is possible to increase versatility in comparison to the technique of Embodiment 1.

### Embodiment 3

In the foregoing, Embodiments 1 and 2 are described for the case of establishing a single SA with respect to different QoS priorities. However, the present invention is not limited to the above. Different SAs may also be established for different QoS priorities, and a plurality of SAs may also share settings such as the encryption key and decryption key.

Therefore, a technique will be described hereinafter as Embodiment 3, wherein a different SA is established for each individual QoS priority, and wherein the plurality of SAs share settings such as the encryption key and the decryption key.

More specifically, a technique will be described wherein, when establishing an SA, the new SA is established by referencing information that was used for already-established SAs. The technique described in Embodiment 3 corresponds to the sequence control format herein referred to as the “Shared-Key Sequence Format”.

In Embodiment 3, the sender SA processor 112 identifies the QoS priority every time a packet is received from the sender termination unit 111, and determines whether or not an SA has been established for the identified QoS priority. For example, the sender SA processor 112 may determine whether or not information corresponding to the SA used for identified QoS priority is being stored in the sender SA storage unit 102.

If the sender SA processor 112 determines that such information is not being stored, or in other words, if an SA has not been established for the identified QoS priority, then the sender IKE processor 113 and the receiver IKE processor 211 in Embodiment 3 establish a new SA.

More specifically, the sender IKE processor 113 sends to the packet-receiving apparatus 200 an IKE packet indicating “Shared-Key Sequence Format” as the preferred sequence control format. Described with reference to the example shown in FIG. 6, a reference QoS indicating the SA to be used as a base of reference is set in the “TRANSFORM ATTRIBUTES” field of the IKE packet. For example, in the case where an SA has already been established for the QoS priority “EF”, and wherein that SA is to be used as the base of reference for a new SA, the sender IKE processor 113 sets the value “SPI[1]”, which identifies the SA for the reference QoS “EF”. Subsequently, if “Shared-Key Sequence Format” is selected as the sequence control format by the receiver IKE processor 211, then the sender IKE processor 113 and the receiver IKE processor 211 establish an SA in the “Shared-Key Sequence Format”.

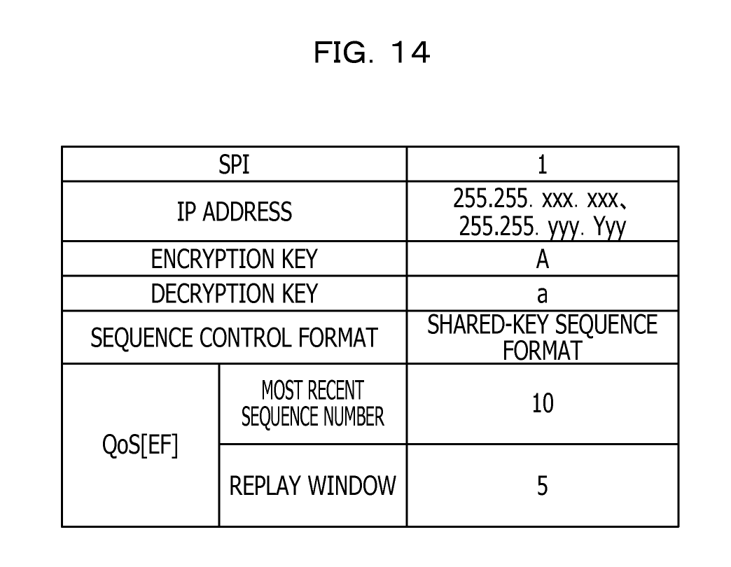

A process for establishing an SA will now be described, taking the receiver IKE processor 211 by way of example. The receiver IKE processor 211 first searches the receiver SA storage unit 202 to determine whether or not the SA specified as the base of reference has already been established. If the receiver IKE processor 211 obtains a search result indicating that the SA has not been established, then the receiver IKE processor 211 cooperates with the sender IKE processor 113 to determine new parameters such as the encryption key and decryption key to be used in the SA, and establishes a completely new SA. For example, as shown in FIG. 14, the receiver IKE processor 211 may determine the encryption key and the decryption key by negotiating with the sender IKE processor 113, and newly establish an SPI “1” for the QoS priority “EF”.

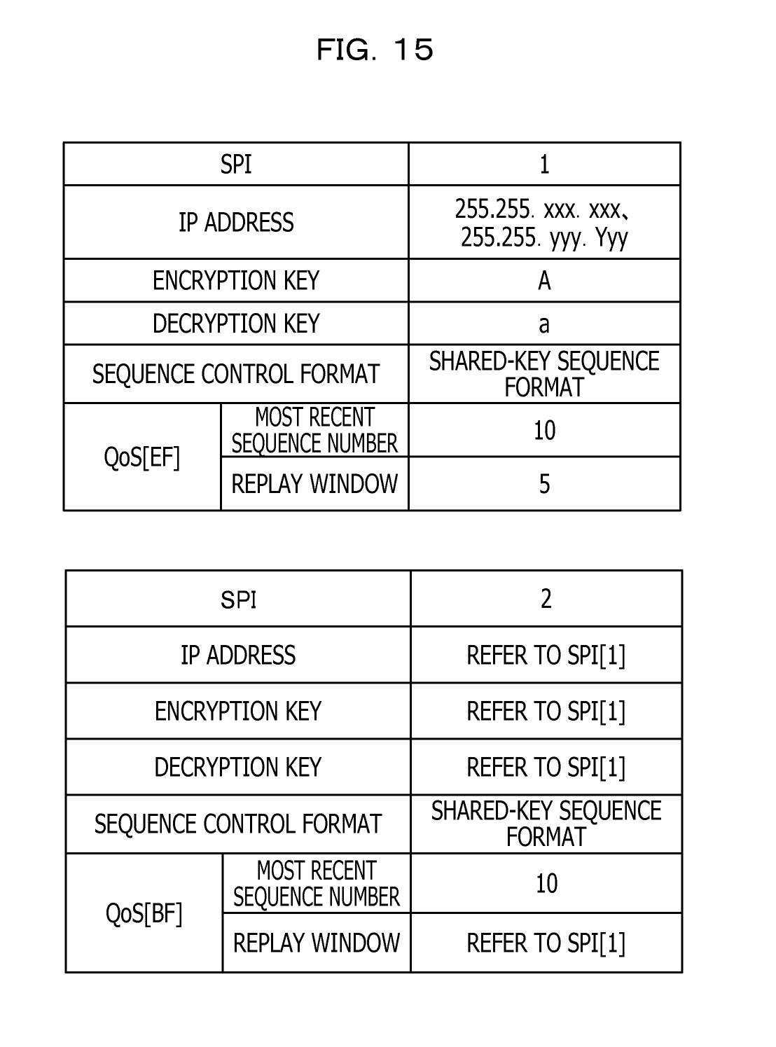

On the other hand, if the receiver IKE processor 211 performs the above search and obtains a search result indicating that the SA specified as the base of reference has been established, then the receiver IKE processor 211 establishes another SA by referencing the encryption key and the decryption key used for the already-established SA. For example, as shown in FIG. 15, the receiver IKE processor 211 newly establishes an SPI “2”. At this point, the receiver IKE processor 211 directly uses the content of the reference SPI “1”, without cooperating with the sender IKE processor 113 to newly determine values for the “IP ADDRESS”, “ENCRYPTION KEY”, and “DECRYPTION KEY” fields. In the example shown in FIG. 15, the receiver termination unit 213 stores “REFER TO SPI[1]” in the “IP ADDRESS”, “ENCRYPTION KEY”, and “DECRYPTION KEY” fields in the receiver SA storage unit 202. In other words, the above fields are linked to the “IP ADDRESS”, “ENCRYPTION KEY”, and “DECRYPTION KEY” fields of SPI “1”. Herein, the sender IKE processor 113 establishes an SA similarly to the receiver IKE processor 211.

In other words, the sender IKE processor 113 and the receiver IKE processor 211 performs searches to determine whether or not the SA specified as the base of reference has been established. In the positive case, or in other words, when the SA specified as the base of reference does exist (or more specifically, when establishing an SA for the second time and thereafter), the sender IKE processor 113 and the receiver IKE processor 211 cooperate to establish an SA using the encryption key and decryption key of the other, established SA, without negotiating to determine a new encryption key and decryption key.

[SA Establishment Process in Embodiment 3]

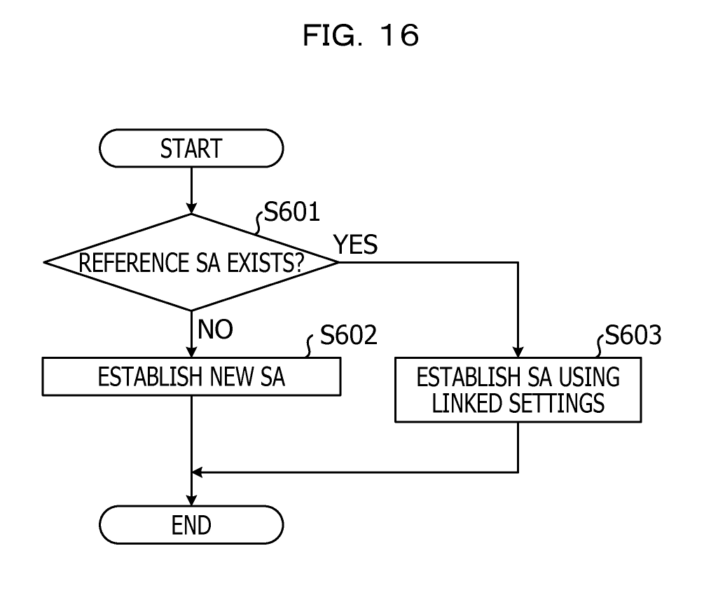

FIG. 16 will now be used to describe the flow of an SA establishment process in Embodiment 3. Herein, FIG. 16 is a flowchart for explaining the flow of an SA establishment process in Embodiment 3. The process shown in FIG. 16 herein corresponds to steps S205 and S206 in FIG. 7.

Hereinafter, it is assumed that the apparatus have already decided to establish an SA using the “Shared-Key Sequence Format” as a result of sending and receiving IKE packets. Thus, the following describes a process for establishing a new SA using the “Shared-Key Sequence Format”. Furthermore, although the following takes the receiver IKE processor 211 by way of example, an SA is established by means of a similar process also executed in the sender IKE processor 113.

As shown in FIG. 16, the receiver IKE processor 211 performs a search to determine whether or not the reference SA exists (step S601). If the receiver IKE processor 211 obtains a search result indicating that the reference SA does not exist (step S601: No), then the receiver IKE processor 211 cooperates with the sender IKE processor 113 to determine parameters such as the encryption key and the decryption key to be used in the SA, and establishes a completely new SA (step S602).

In contrast, if the receiver IKE processor 211 obtains a search result indicating that the reference SA does exist (step S601: Yes), then the receiver IKE processor 211 establishes an SA configured such that its parameters are linked to the encryption key and the decryption key used for the already-established reference SA (step S603).

### Advantages of Embodiment 3

As described above, according to Embodiment 3, the packet-sending apparatus 100 establishes a different SA for each individual QoS priority. In addition, when establishing an SA, the sender IKE processor 113 and the receiver IKE processor 211 determine whether or not an SA has been established for another priority different from the QoS priority for which the new SA is to be established. If it is determined that such an SA has been established, then the new SA is established sharing the information used for the already-established SA. As a result, according to Embodiment 3, it is possible to omit the process of negotiating to determine parameters such as the encryption key and the decryption key every time an SA is to be established. Furthermore, by establishing an SA by referencing parameters such as the encryption key and the decryption key of another SA, it is possible to suppress increases in the amount of data to be managed, even in the case of a plurality of SAs.

### Embodiment 4

In the foregoing Embodiment 1, a technique is described wherein a replay attack check is executed using the most recent sequence number and the replay window size. However, the present invention is not limited to the above. For example, the packet-receiving apparatus 200 may also execute replay attack checks by storing a history for each priority in the form of a predetermined number of sequence numbers attached to packets received from the packet-sending apparatus.

Therefore, a technique will be hereinafter described wherein the receiver SA storage unit 202 stores a history for each priority in the form of a predetermined number of sequence numbers. In addition, a technique will be described wherein the receiver SA processor 212 performs a cross-reference to determine whether or not a given sequence number duplicates one of the sequence numbers contained in the history, and whether or not the given sequence number is smaller than the smallest sequence number contained in the history. The techniques described in Embodiment 4 are also herein referred to as the “Sequence Number Retention Format”.

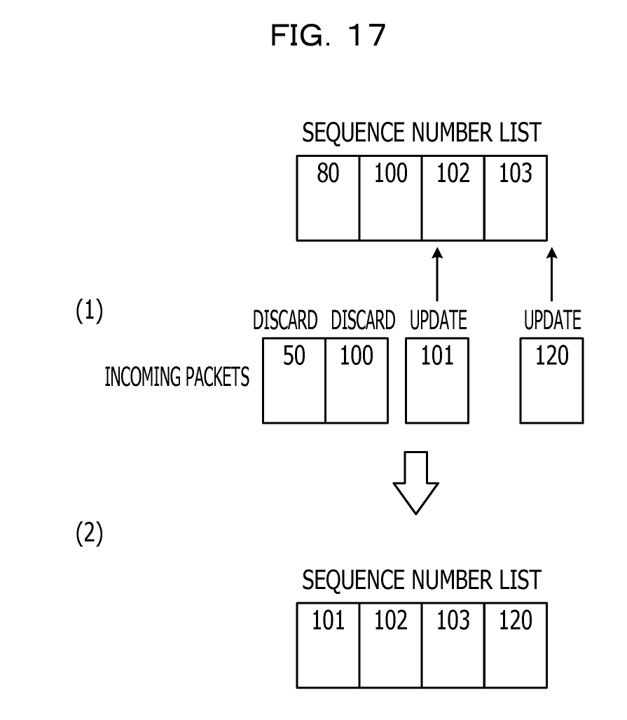

More specifically, the receiver SA storage unit 202 stores a history for each priority in the form of a predetermined number of sequence numbers attached to packets received from the packet-sending apparatus 100. For example, in the example shown at (1) in FIG. 17, the receiver SA storage unit 202 stores four sequence numbers, herein storing “80”, “100”, “102”, and “103” by way of example. Herein, FIG. 17 is a diagram for explaining a replay attack check process conducted using the Sequence Number Retention Format.

The receiver SA processor 212 then executes a replay attack check by cross-referencing the sequence number attached to a received packet with the sequence number history stored in the receiver SA storage unit 202. More specifically, the receiver SA processor 212 checks to determine whether or not the given sequence number duplicates one of the sequence numbers contained in the history, and whether or not the given sequence number is smaller than the smallest sequence number contained in the history.

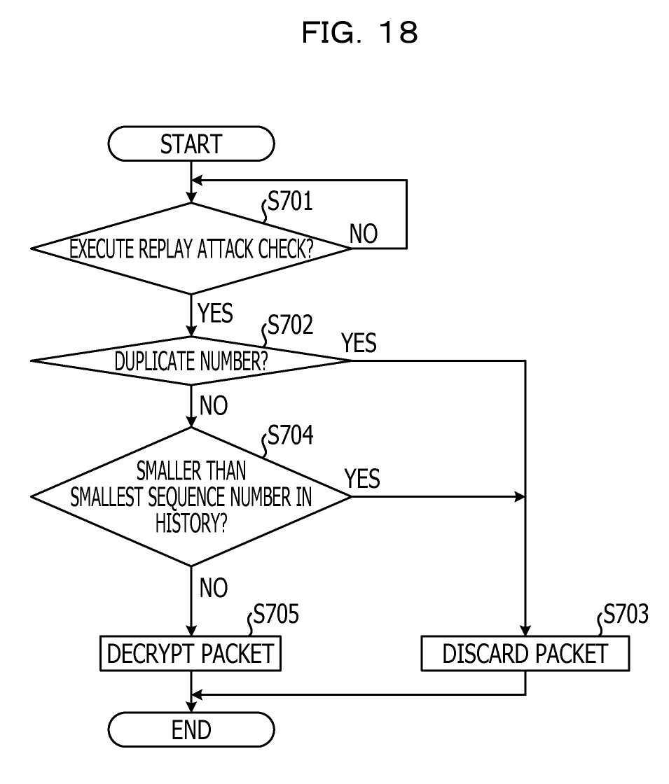

The above process will now be described in further detail using FIG. 18. Herein, FIG. 18 is a flowchart for explaining the flow of a replay attack check process conducted using the Sequence Number Retention Format. As shown in FIG. 18, when executing a replay attack check (step S701: Yes), the receiver SA processor 212 first checks whether or not the sequence number attached to the received packet duplicates one of the sequence numbers contained in the history (step S702). Taking the example shown at (1) in FIG. 17, in the case where the sequence number attached to the received packet is “100”, it is determined that the given sequence number duplicates one of the sequence numbers contained in the history (step S702: Yes), and thus the packet is discarded (step S703).

In the case where the given sequence number is determined to not duplicate one of the sequence numbers contained in the history (step S702: No), the receiver SA processor 212 next checks whether or not the sequence number attached to the received packet is smaller than the smallest sequence number contained in the history (step S704). Taking the example shown at (1) in FIG. 17, in the case where the sequence number attached to the received packet is “50”, it is determined that the given sequence number is smaller than the smallest sequence number contained in the history (step S704: Yes), and thus the packet is discarded (step S703).

On the other hand, if the given sequence number is determined to not be smaller than the smallest sequence number contained in the history (step S704: No), then the packet is decrypted (step S705). In the present example, the received packet is decrypted in the case where the sequence number attached to the packet is a number such as “101” or “120”.

In addition, the receiver SA processor 212 updates the sequence numbers contained in the history. For example, as shown at (2) in FIG. 17, the receiver SA processor 212 deletes the numbers “80” and “100” from the history and stores the numbers “101” and “120”, thereby updating the history to the four numbers “101”, “102”, “103”, and “120”.

As described earlier, when executing replay attack checks, the packet-receiving apparatus 200 may store a history of sequence numbers for each QoS priority, even if the packet-sending apparatus 100 does not attach a different series of sequence numbers for each priority.

Also, in the case of conducting replay attack checks using the Sequence Number Retention Format, information indicating that replay attack checks using the Sequence Number Retention Format are preferred may be set in the IKE packet when establishing an SA.

### Advantages of Embodiment 4

In this way, by conducting replay attack checks using the Sequence Number Retention Format, it is possible to omit the replay window size. Furthermore, it is possible to prevent the invalid discarding of packets, even if the order in which packets are received by the packet-receiving apparatus 200 greatly differs from the order in which packets are sent by the packet-sending apparatus 100. For example, given a technique that uses a replay window size, as in Embodiment 1, invalid discarding of packets will occur when the send order and the receive order differ by an amount greater than the replay window size. In contrast, if replay attack checks are conducted using the Sequence Number Retention Format, it becomes possible to prevent this phenomenon from occurring.

Moreover, it is possible to prevent the invalid discarding of packets even in the case where, for example, a different series of sequence numbers is not attached for each QoS priority. This advantage will now be described using the example shown at (1) in FIG. 10. More specifically, in this example, the sequence numbers “9” to “15” are attached to consecutive packets set with the QoS priority “EF”, while the sequence numbers “8” and “16” are attached to consecutive packets set with the QoS priority “BE”. Given a replay window size of “4”, for example, consider the case where the receive order for “8” and “16” is switched, thus becoming “16”, “8”. Under such circumstances, a packet-receiving apparatus of the related art would discard the “8” packet that arrives later. In contrast, according to Embodiment 4, it is determined whether or not a given sequence number duplicates one of the sequence numbers in the history, and also whether or not the given sequence number is smaller than the smallest sequence number in the history. In so doing, it is possible to prevent the invalid discarding of packets.

### Embodiment 5

The foregoing thus describes exemplary embodiments of the present invention, but it should be appreciated that the present invention may also be carried out in embodiments other than those described in the foregoing. Hereinafter, one such other embodiment will be described.

[Replay Attack Check Using Most Recent Sequence Number Format]

For example, the packet-receiving apparatus 200 may also execute a replay attack check by simply comparing the magnitude of the sequence number attached to the received packet against the most recent sequence number.

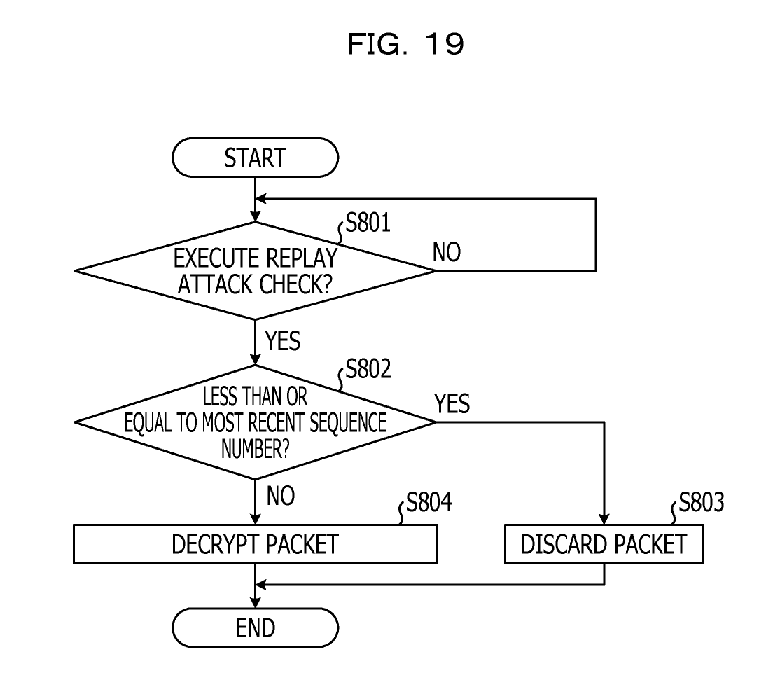

More specifically, the receiver SA storage unit 202 stores a history for each priority in the form of just the most recent sequence number among the sequence numbers attached to received packets. As shown in FIG. 19, in the case where the receiver SA processor 212 subsequently executes a replay attack check (step S801: Yes), the receiver SA processor 212 determines whether or not a given sequence number is less than or equal to the most recent sequence number (step S802). If the given sequence number is less than or equal to the most recent sequence number (step S802: Yes), then the receiver SA processor 212 discards the packet (step S803). In contrast, if the given sequence number is not less than or equal to the most recent sequence number (step S802: No), then the receiver SA processor 212 decrypts the packet (step S804). Herein, FIG. 19 is a flowchart for explaining the flow of a replay attack check process conducted using a Most Recent Sequence Number Format.

In this way, in an environment where switching in the send order and the receive order does not occur, for example, replay attack checks may be executed using just the most recent sequence number. In so doing, the processing load when executing a replay attack check is reduced, and it becomes possible to realize fast and low-load replay attack checks.

### Embodiment Combinations

As another example, the “Sequence Number Retention Format” described in Embodiment 4 or the “Most Recent Sequence Number Format” described in Embodiment 5 may also be carried out in combination with the “List Sequence Format”, the “Independent Sequence Format”, or the “Shared-Key Sequence Format” described in Embodiments 1, 2, and 3.

[System Configuration]

Some or all of the respective processes described as being automatically conducted in the foregoing embodiments may also be conducted manually. Likewise, some or all of the respective processes described as being manually conducted may also be conducted automatically by an established method. For example, in the foregoing embodiments, a technique for automatically establishing an SA was described. However, the present invention is not limited thereto, and an administrator who manages the packet transmission system may also manually establish an SA.

In addition, the processing steps, control steps, specific names, and information containing various data and parameters that are described in the foregoing text and in the drawings (i.e., FIGS. 1 to 19) may also be changed, unless otherwise specified. For example, in the example shown in FIG. 18, steps S702 and S704 may be switched.

Furthermore, the individual component elements of the respective apparatuses illustrated in the drawings are conceptual representations of structure and/or functions, and the apparatuses are not limited to being physically configured in the same manner as those shown in the drawings. In other words, the specific way in which the respective apparatuses are separated or integrated is not limited to that shown in the drawings. Depending on various requirements and usage conditions, some or all of such component elements may be functionally or physically separated or integrated on different bases. For example, when described using the example shown in FIG. 2, the components included in the packet-sending apparatus 100 and the packet-receiving apparatus 200 may be combined and provided as a packet transmission apparatus.

[Computer]

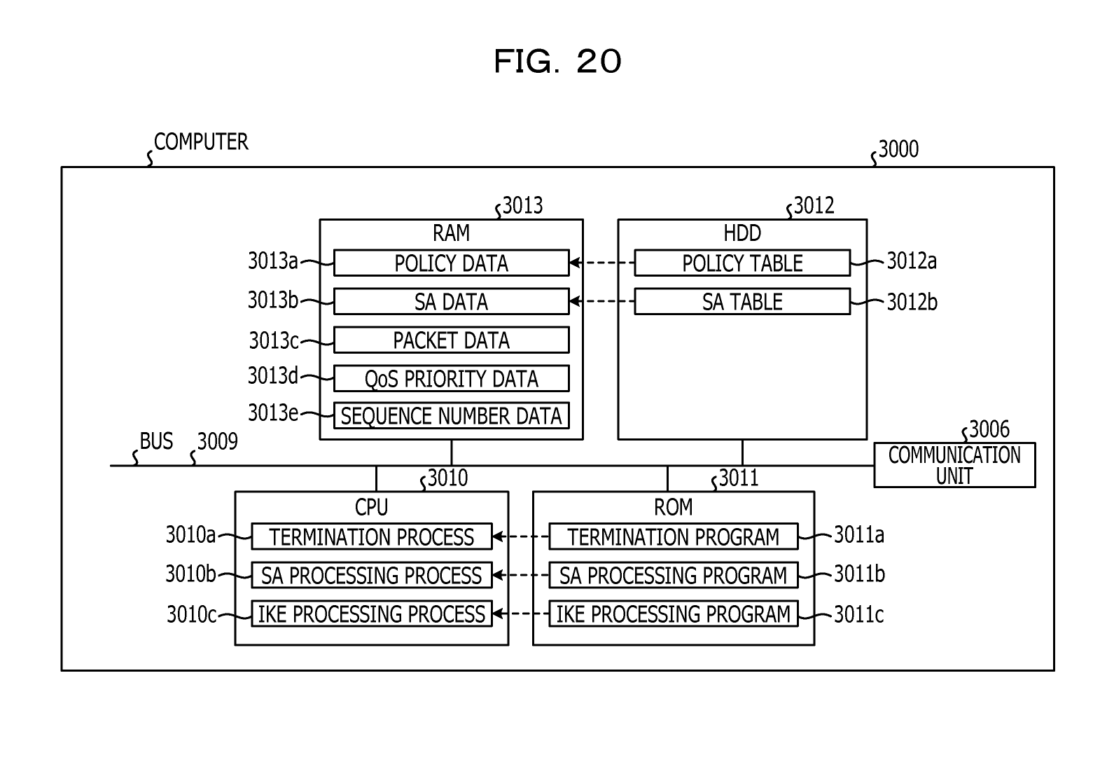

Furthermore, the various processes described in the foregoing embodiments may be realized as a result of a personal computer, workstation, or similar computer executing a program that has been prepared in advance. Hereinafter, FIG. 20 will be used to describe an example of a computer that executes a packet transmission program, wherein the program includes features similar to those of a system provided with the combined features of the packet-sending apparatus 100 and the packet-receiving apparatus 200 described in the foregoing. Herein, FIG. 20 is a diagram for explaining an example of a computer that executes a packet transmission program in accordance with Embodiment 1.

As shown in FIG. 20, the computer 3000 includes a central processing unit (CPU) 3010, read-only memory (ROM) 3011, a hard disk drive (HDD) 3012, and random access memory (RAM) 3013, the above being connected by means of a bus 3009 or similar component.

The ROM 3011 is provided with a control program that exhibits similar features to those of the sender termination unit 111 and receiver termination unit 213, the sender SA processor 112 and receiver SA processor 212, and the sender IKE processor 113 and receiver IKE processor 211 described in the foregoing Embodiment 1. In other words, as shown in FIG. 20, a termination program 3011a, an SA processing program 3011b, and an IKE processing program 3011c are stored in the ROM 3011 in advance. It should be appreciated that the programs 3011a to 3011c herein may also be integrated or separated as appropriate, similarly to the respective components of the packet-sending apparatus 100 and the packet-receiving apparatus 200 shown in FIG. 2.

As a result of the CPU 3010 reading out and executing the programs 3011a to 3011c from the ROM 3011, the programs 3011a to 3011c respectively function as a termination process 3010a, an SA processing process 3010b, and an IKE processing process 3010c, as shown in FIG. 20. The processes 3010a to 3010c respectively correspond to the sender termination unit 111 and receiver termination unit 213, the sender SA processor 112 and receiver SA processor 212, and the sender IKE processor 113 and receiver IKE processor 211 shown in FIG. 2.

In addition, a policy table 3012a and an SA table 3012b are provided in the HDD 3012. The tables 3012a and 3012b respectively correspond to the sender policy storage unit 101 and receiver policy storage unit 201, and to the sender SA storage unit 102 and receiver SA storage unit 202 shown in FIG. 2.

The CPU 3010 reads out the policy table 3012a and SA table 3012b and stores the table in the RAM 3013. Using the policy data 3013a, SA data 3013b, packet data 3013c, QoS priority data 3013d, and sequence number data 3013e stored in the RAM 3013, the CPU 3010 subsequently executes the packet transmission program.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet transmission system, comprising:
a packet-sending apparatus; and
a packet-receiving apparatus;
wherein the packet-sending apparatus comprises
a sending unit configured to attach a sequence number which is numbered for each priority of QoS set in a first packet to be sent, the sequence number is numbered for each priority of QoS set in the first packet, and to send the first packet with the sequence number attached,
the packet-receiving apparatus comprises
a storage unit configured to store, for each priority, a history of sequence numbers attached to packets received from the packet-sending apparatus,
a determining unit configured to receive the first packet from the packet-sending apparatus, to identify the sequence number of the first packet, and to determine whether or not the first packet has been previously received by comparing the identified sequence number with the history of sequence numbers according to the priority of QoS set in the first packet stored in the storage unit, and
a unit configured, when the determining unit determines the first packet has been previously received, to discard the first packet.

2. The packet transmission system according to claim 1, wherein
the sending unit sends priority identification information that identifies the priority of QoS set in the first packet, and
the packet-receiving apparatus is provided with a priority unit configured to receive the priority identification information from the packet-sending apparatus, to store the priority identification information in the storage unit, and to cause a history of sequence numbers to be stored for each set of priority identification information.

3. The packet transmission system according to claim 2, wherein
the packet-receiving apparatus is provided with a search unit configured to receive the first packet from the packet-sending apparatus, to perform a search to determine whether or not priority identification information indicating the priority of QoS set in the first packet is being stored in the storage unit, and
when the search unit obtains a search result indicating that the priority identification information is not being stored, the search unit stores the priority identification information indicating the priority of QoS set in the first packet in the storage unit, and causes a history of sequence numbers to be stored in association with the priority identification information.

4. The packet transmission system according to claim 1, wherein
the packet-receiving apparatus is provided with an establishing unit configured to establish a different security association for each individual priority of QoS,
when establishing a security association with the packet-sending apparatus, the establishing unit determines whether or not a security association has been already established for a priority of QoS that is different from the priority of QoS for which a security association is to be established, and
when it is determined that such an already-established security association has been established, the establishing unit establishes a security association that shares information used for the already-established security association.

5. The packet transmission system according to claim 2, wherein
the storage unit stores a history for each priority in the form of a predetermined number of sequence numbers attached to packets received from the packet-sending apparatus,
when comparing the sequence number attached to the first packet with the history stored in the storage unit, the determining unit determines whether or not the first packet has been previously received by determining whether or not the sequence number attached to the first packet duplicates one of the sequence numbers contained in the history, and by determining whether or not the sequence number is smaller than a smallest sequence number contained in the history.

6. The packet transmission system according to claim 1, wherein
the storage unit stores a history for each priority in the form of just a most recent sequence number attached to the first packet.

7. A packet transmission apparatus, comprising:
a sending unit configured to attach a sequence number which is numbered for each priority of QoS set in a first packet to be sent, the sequence number is numbered for each priority of QoS set in the first packet, and to send the first packet with the sequence number attached;
a storage unit configured to store, for each priority, a history of sequence numbers attached to packets received from another packet transmission apparatus;
a determining unit configured to receive a second packet from the another packet transmission apparatus, to identify the sequence number of the second packet, and to determine whether or not the second packet has been previously received by comparing the identified sequence number with the history of sequence numbers according to the priority of QoS set in the second packet stored in the storage unit; and
a unit configured, when the determining unit determines the second packet has been previously received, to discard the second packet.

8. A packet transmission method executed by a packet transmission system comprising a packet-sending apparatus and a packet-receiving apparatus provided with a storage unit configured to store, for each priority, a history of sequence numbers attached to packets received from the packet-sending apparatus, the method comprising the steps of:
attaching a sequence number which is numbered for each priority of QoS set in a first packet to be sent, the sequence number being numbered for each priority of QoS set in the first packet;
sending the first packet with the sequence number attached;
receiving the first packet;
identifying the sequence number of the first packet;
determining whether or not the first packet has been previously received by comparing the identified sequence number with the history of sequence numbers according to the priority of QoS set in the first packet stored in the storage unit; and
discarding, when the first packet has been previously received, the first packet.
